(19) United States
(12) Patent Application Publication
(10) Pub. No.: US 2025/0314551 A1
(43) Pub. Date: Oct. 9, 2025

(54) AIRFLOW RESISTANCE AND AIR LEAKAGE MEASUREMENT DEVICE

(71) Applicant: Sound Solutions International (Zhenjiang) Co., Ltd., Zhenjiang City (CN)

(72) Inventors: Andreas Hintennach, Guntramsdorf (AT); Stefan Leitner, Tribuswinkel (AT); Reinhard Santin, Baden (AT)

(21) Appl. No.: 19/096,119

(22) Filed: Mar. 31, 2025

(30) Foreign Application Priority Data
Apr. 8, 2024 (AT) A50293/2024

(51) Int. Cl. G01M 3/32; G06F 17/11; H04R 29/00

(52) U.S. Cl. CPC G01M 3/3263; G06F 17/11; H04R 29/001

(57) ABSTRACT

A method and a test device (2a . . . 2i) for measuring an airflow resistance of an enclosure (10) of a closed volume (B) is disclosed, where an internal pressure (pᵢₙₜ) within the closed volume (B) is changed by a pressure generator (5a . . . 5e) and a pressure difference (Δp) between the internal pressure (pᵢₙₜ) and the external pressure (pₑₓₜ) is measured by a pressure sensor (6, 6a . . . 6d). Furthermore, a change of said measured pressure difference (Δp) over time (t) and/or an airflow into or out of the closed volume (B) or a volume change rate of the closed volume (B) generated by the pressure generator (5a . . . 5e) is detected and the airflow resistance is derived thereof by an evaluation circuit (7). A size of the closed volume (B) is in a range of 2 cm³ to 40 cm³ and the pressure difference (Δp) is in a range of 1 Pa to 480 Pa. Furthermore, a test arrangement (1a . . . 1i) with a test device (2a . . . 2i) and a test object (3a . . . 3i) connected thereto is disclosed.

### PRIORITY

This patent application claims priority from provisional Austrian Patent Application No. A50293/2024, filed Apr. 8, 2024, entitled, “Airflow Resistance and Air Leakage Measurement Device,” the disclosure of which is incorporated herein, in its entirety, by reference.

### BACKGROUND

The invention relates to a method for measuring an airflow resistance of an enclosure of a closed volume (in particular of an aperture or a mesh being arranged in the enclosure and adjoining the closed volume). First, an internal pressure within the closed volume is changed in view of an external pressure in the environment of the closed volume by a pressure generator. Further on, a pressure difference between the internal pressure and the external pressure is measured by a pressure sensor. Finally, in a case a) a change of said measured pressure difference over time is detected and the airflow resistance is derived thereof by an evaluation circuit. In a case b) an airflow into or out of the closed volume generated by the pressure generator or a volume change rate of the closed volume generated by the pressure generator is detected and the airflow resistance is derived thereof by an evaluation circuit.

Moreover, the invention relates to a test device for measuring an airflow resistance of an enclosure of a closed volume (in particular of an aperture or a mesh being arranged in the enclosure and adjoining the closed volume). The test device comprises a test device housing, a pressure generator, a pressure sensor and an evaluation circuit. The test device housing at least partly encloses the closed volume. The pressure generator is connected to the test device housing and is provided to change an internal pressure within the closed volume in view of an external pressure in the environment of the closed volume. The pressure sensor is designed to measure a pressure difference between the internal pressure and the external pressure. Finally, the evaluation circuit is designed a) to detect a change of said measured pressure difference over time and to derive the airflow resistance thereof and/or b) to detect an airflow into or out of the closed volume generated by the pressure generator or a volume change rate of the closed volume generated by the pressure generator and to derive the airflow resistance thereof.

Finally, the invention relates to a test arrangement, which comprises a test device and a test object connected thereto. The test device here additionally comprises a connector, by which the test object is connected to the test device, wherein the connector is arranged in the test device housing. The closed volume is encompassed by the test device housing and a test object housing of the test object.

A method, a test device and a test arrangement of the aforementioned kinds are generally known in prior art. In common designs, a (piston) compressor generates compressed air, which is lead to a test object via a compressed air line, and a flow rate sensor measures an airflow through an aperture or mesh of the test object. However, the known methods suffer from comparably strong turbulences, which is a reason why comparably high pressures are used for the measurement so as to have a good signal to noise ratio (SNR). However, high pressures cause high flow rates which in turn also cause higher turbulences so that the effect of an improved SNR is undermined to some degree. Further on, high pressures may be problematic for fragile test objects.

### SUMMARY OF THE INVENTION

Accordingly, it is an object of the invention to overcome the drawbacks of the prior art and to provide an improved method, an improved test device and an improved test arrangement for measuring an airflow resistance. In particular, strong air turbulences and high pressures shall be avoided at the same time without leading to an unusably long measuring duration.

The problem of the invention is solved by a method, a test device and a test arrangement as defined in the opening paragraph, wherein a size of the closed volume is in a range of 2 cm³ to 40 cm³ and the pressure difference is in a range of 1 Pa to 480 Pa.

By the proposed measures, strong air turbulences and high pressures are avoided without leading to an unusably long measuring duration. So, in particular, the airflow resistance of fragile test objects can be measured. In more general terms, an airflow resistance of an enclosure of a closed volume can be measured. So, on the one hand, an airflow resistance of, for example, an aperture or a mesh being arranged in the enclosure and adjoining the closed volume can be measured. On the other hand, the proposed measures may also be used for checking or testing an airtightness of the enclosure, which for example may be formed by a housing of a test device and/or a housing of a test object.

The proposed ranges for the size of the closed volume and the pressure difference are particularly advantageous in the context of measuring airflow resistances of acoustic devices and components. More particularly, the proposed ranges allow for fast measuring sequences and reliable measuring values without risking a damage of the tested acoustic components by applying to much pressure.

In more detail, the proposed measures are particularly useful if the test object is formed by an acoustic transducer (e.g. a microphone, a speaker or a headphone), an acoustic component for an acoustic transducer (e.g. a membrane or equalization means like a mesh) or a material for an acoustic component of an acoustic transducer (e.g. a membrane material, a damping foam, a porous material or a mesh material). All these test objects are sensitive to excessive pressure. That is why the proposed method, the proposed test device and the proposed test arrangement are particularly suitable for measuring an airflow resistance of the above transducers, components or materials.

In particular, the airflow resistance can be in a range of 20·10⁶ Pa·s/m³ to 300·10⁹ Pa·s/m³ or in a range of 20 Acoustic MOhm to 300 Acoustic GOhm respectively. That means, the proposed measures are particularly suitable for measuring an airflow resistance in the given range and thus particularly apply to measurements of apertures, meshes or mesh materials having an acoustic resistance (which is a real part of an acoustic impedance) in a range of 20·10⁶ Pa·s/m³ to 300·10⁹ Pa·s/m³ or in a range of 20 Acoustic MOhm to 300 Acoustic GOhm respectively.

The aforementioned advantages are particularly prominent if the pressure generator comprises a surface, which is movable or deflectable in a controlled manner and which adjoins the closed volume. In this way, turbulences caused by a compressed air line coming from a compressor can be avoided, and there are no or just minor air turbulences in the closed volume during a pressure change.

Generally, a pressure generator of whatever kind directly adjoining the closed volume can be used in the above context. However, it is advantageous if the pressure generator is designed as a piston compressor, wherein the movable surface is formed by a surface of a piston of the piston compressor. In particular, a pressure change for a (one) measurement is accomplished by moving the piston in just one direction. That means, beneficially there is no forth and back movement of the piston during a measurement in contrast to the operation of standard compressors, which compress air by use of a forth and back movement of the piston and by use of valves. Such a forth and back movement in case of a standard compressor causes massive pressure fluctuations unless they are suppressed by special measures like big air tanks switched between the compressor and the test object. One further advantage of the proposed arrangement is that no valves are needed for the operation of its compressor. So, the proposed compressor is easy to manufacture and operates reliably.

In an alternative advantageous embodiment, the pressure generator can be designed as a speaker, wherein the deflectable surface is formed by a surface of an actively deflectable membrane of the speaker. Commonly, the task of a speaker is generation of sound. However, in this application, the speaker is used to generate compressed air. Advantageously, the membrane can be moved very fast and its movement can be controlled very precisely so that fast and exact pressure changes are possible. In particular, there is no stick-slip effect (sudden transition from static friction to sliding friction) as it is the case, for example, with piston compressors. It should be noted that the membrane can deflect as a whole or can comprise an inner part, which moves like a piston, and an outer part, which is deflected.

It should also be noted that the speaker may form the pressure generator and the test device at the same time, and there is no further test object connected to the test device. In this case, the proposed measures are advantageously used for measuring the airflow resistance of an aperture or mesh in a housing of the speaker or to check the airtightness of the speaker. The closed volume is formed by the back volume of the speaker in this case.

Generally, a speaker can comprise a speaker housing, a magnet system arranged in the speaker housing and a voice coil arranged in an airgap of the magnet system. For example, the magnet system may comprise a magnet, a top plate made of soft iron and a pot made of soft iron. However, because the function of a speaker is known, it is not explained in more detail herein.

It is particularly advantageous in this context, if the pressure sensor is formed by the actively deflectable membrane of the speaker and a laser distance sensor directed to the actively deflectable membrane, wherein the laser distance sensor measures a deflection of said membrane. It should be noted in this context that a deflection of the speaker's membrane reflects the internal pressure within the back volume only or purely if the enclosure of the back volume (in particular the speaker housing) comprises no apertures or meshes or if the apertures or meshes are sealed before measurement. If the apertures or meshes are not sealed, the deflection of the membrane can be used to calculate a volume changing rate or a volume change. The volume changing rate may be calculated by use of the speed of the membrane, and the volume change may be calculated by use of the position or excitation of the membrane.

The proposed measures cannot not only be used for testing an airflow resistance in the aforementioned range, but may also be used for checking the airtightness of a test object and in particular of a speaker. In an advantageous embodiment, the measured airflow resistance is qualified as infinite if it is larger than 300·10⁹ Pa·s/m³ or 300 Acoustic GOhm respectively. Accordingly, a test device housing and/or a test object housing is qualified as airtight above the given threshold value of the measured airflow resistance.

For example, the airflow resistance of a speaker can be tested by exciting the membrane and by detecting (a possible) change of its deflection over time. Based on a change of the deflection and thus based on a pressure change, the airflow resistance of the speaker can be calculated. If no or just a minor change is detected, airtightness of the speaker can be confirmed.

In case of a speaker, the measured airflow resistance moreover can be qualified as infinite (and the speaker can be qualified as airtight)
if a drop of a resonance frequency of the speaker caused by the measured airflow resistance is less than 1% in view of the resonance frequency of the speaker in the airtight condition or
if a change of an impedance frequency response curve of the speaker caused by the measured airflow resistance at any frequency is less than 1% in view of the impedance of the speaker in the airtight condition.

Generally, if a leakage is too high, apart from a drop of the resonance frequency the excursion of the speaker membrane rises in view of an excursion in the airtight condition provided the same electrical signal is applied to the speaker. This may lead to undesired noise and mechanical problems because the speaker membrane may hit parts of the speaker or parts of a device, which the speaker is built into.

In general, one or more apertures and/or one or more meshes in the enclosure of the closed volume can be sealed before the internal pressure is changed. In this way, on the one hand, the airtightness of the enclosure can be tested if all intended or known apertures and/or meshes are sealed. On the other hand, the measurement of an airflow resistance can be limited to one or more specific aperture(s) and/or meshes in the enclosure which are kept open if there are more intended or known apertures and/or meshes.

Generally, the proposed method both applies to increasing or decreasing the internal pressure within the closed volume in view of an external pressure. However, measurements with increased and decreased internal pressure may lead to different results of the airflow resistance as the case may be. A reason may be a non-symmetric aperture or duct in the enclosure causing different flow conditions for inflow to and outflow from the closed volume.

The proposed method before changing an internal pressure may also comprise the step of connecting a test object to the test device, wherein the closed volume then is encompassed by the test device housing and a test object housing of the test object.

It should also be noted that case b) both relates to a (real) airflow into or out of the closed volume generated by the pressure generator and to a volume change rate of the closed volume generated by the pressure generator. The latter can also be considered as a (virtual) airflow into or out of the closed volume. Strictly speaking, the size of the closed volume may change over time when the internal pressure is changed. For example, this is true if a piston or membrane of the pressure generator adjoins the closed volume. However, if the volume change caused by the by the pressure generator is small compared to the size of the closed volume, the latter can be considered to be constant and set to an initial value, an end value or an average value. The very same counts for the (total) volume change, which can be considered as a (total) shifted volume. The size of the shifted volume corresponds to the total excitation of the pressure generator or the time integral of the airflow generated by the pressure generator respectively.

Because case b) both relates to a real airflow and to a virtual airflow (corresponding to the volume change rate), a real airflow and a virtual airflow are synonymously meant in the following disclosure by the simple term “airflow” without explicitly denoting whether the air airflow is real or virtual.

Further on, in case b) “detection” of the airflow includes methods where the airflow is measured by a dedicated sensor but also includes methods, where the airflow for example is derived from a position or excitation of the piston of a piston compressor or from a position or excitation of the membrane of a speaker. Moreover, methods are included, where the airflow for example is derived from a control signal to the pressure generator, which is linked to a position or excitation of the piston of a piston compressor or to a position or excitation of the membrane of a speaker independent of whether an open loop airflow control or closed loop airflow control is used. Even a target value for the airflow in an open loop airflow control or closed loop airflow control can form a base for the airflow detection.

Further advantageous embodiments are disclosed in the claims and in the de-scription as well as in the figures.

In an advantageous embodiment, the airflow resistance R
i) can be calculated by means of the formula

$$R = \frac{{τ}_{c h 1}}{C}$$

wherein τ_{ch1} is a time constant of a first exponential change of the internal pressure pᵢₙₜ=p₀−(p₀−pₑₓₜ)·e^{-tch1/τch1} in the closed volume starting at a pressure difference Δp=0, wherein τ_{ch1} is a duration of the first exponential change, wherein p₀ is the limiting value of the internal pressure pᵢₙₜ in the closed volume after infinite duration t_{ch1}, wherein pₑₓₜ is the external pressure, wherein C=V_{shf}/(p₀−pₑₓₜ) is a pressurized air capacity of the closed volume and wherein V_{shf} is the size of the volume shifted by the pressure generator at the duration t_{ch1} or
ii) can be calculated by means of the formula

$$R = \frac{{τ}_{c h 2}}{C}$$

wherein τ_{ch2} is a time constant of a second exponential change of the internal pressure pᵢₙₜ=p₀′·e^{-tch2/τch2} in the closed volume starting at Δp≠0, wherein p₀′ is the internal pressure in the closed volume at the start of the pressure change, wherein pₑₓₜ is the external pressure, wherein t_{ch2} is a duration of the second exponential change, wherein C=V_{shf}/(p₀′−pₑₓₜ) is a pressurized air capacity of the closed volume and wherein V_{shf} is the size of the volume shifted by the pressure generator at the duration t_{ch2}.

In case i) the first exponential change starts at a pressure difference Δp=0 and ends at a pressure difference Δp≠0. In case ii) the second exponential change starts at a pressure difference Δp≠0 and ends at a pressure difference Δp=0. Both t_{ch1} and t_{ch2} denote time spans of a pressure change. τ_{ch1} denotes the time of a pressure change starting at Δp=0, and t_{ch2} denotes the time of a pressure change starting at Δp≠0. In case that the internal pressure pᵢₙₜ is increased over the external pressure pₑₓₜ, t_{ch1} can be seen as rise time and t_{ch2} can be seen as drop time. If the internal pressure pᵢₙₜ is decreased in view of the external pressure pₑₓₜ, t_{ch1} can be seen as drop time and t_{ch2} can be seen as rise time. For example, the time constants τ_{ch1} or τ_{ch2} can be calculated by measuring the internal pressure pᵢₙₜ at two different points in time. The size V_{shf} of the volume shifted by the pressure generator at or until the duration τ_{ch1} can be seen as the time integral of the airflow q_{gen} generated by the pressure generator or as the size of a movable or deflectable surface of pressure generator multiplied by its excitation.

In the above context, the airflow resistance R
in case i) advantageously can be calculated by means of a first approximated internal pressure p_{A1}=p₀−(p₀−pₑₓₜ)·e^{-tch1/τA1}, which is approximated to the real internal pressure pᵢₙₜ=p₀−(p₀−pₑₓₜ)·e^{-tch1/τch1}, wherein τ_{A1} is a time constant of an exponential change of the first approximated internal pressure p_{A1}, or
in case ii) advantageously can be calculated by means of a second approximated internal pressure p_{A2}=p₀′·e^{-tch2/τA2}, which is approximated to a real internal pressure pᵢₙₜ=p₀′·e^{-tch2/τch2}, wherein τ_{A2} is a time constant of an exponential change of the second approximated internal pressure p_{A2}.

Generally, disturbances causing fluctuations of or noise in a measured (real) internal pressure pᵢₙₜ in the closed volume can distort the pressure measurement and thus the calculation of the airflow resistance R. However, by approximating the internal pressure pᵢₙₜ, the calculation of the airflow resistance R can be made more resistant against disturbances and noise. For the approximation, in particular, a least mean square algorithm can be used.

In another advantageous embodiment, the airflow resistance R
i) can be calculated by means of the formula

$$R = \frac{1}{{q}_{g e n}} \cdot \frac{d {p}_{i n t}}{d t}$$

wherein dpᵢₙₜ/dt is the time gradient of a first exponential change of the internal pressure pᵢₙₜ=p₀−(p₀−pₑₓₜ)·e^{-tch1/τch1} in the closed volume at t_{ch1}=0, wherein the first exponential change starts at a pressure difference Δp=0, wherein pₑₓₜ is the external pressure, wherein t_{ch1} is a time constant of the first exponential change, wherein τ_{ch1} is a duration of the first exponential change, wherein p₀ is the limiting value of the internal pressure pᵢₙₜ in the closed volume after infinite duration t_{ch1} and wherein q_{gen} is the airflow generated by the pressure generator, or
ii) can be calculated by means of the formula

$$R = \frac{1}{{q}_{g e n}} \cdot \frac{d {p}_{i n t}^{′}}{d t}$$

wherein dpᵢₙₜ′/dt is the time gradient of a second exponential change of the internal pressure pᵢₙₜ=p₀′·e^{-tch2/τch2} in the closed volume at t_{ch2}=0, wherein the second exponential change starts at Δp≠0, wherein pₑₓₜ is the external pressure, wherein p₀′ is the internal pressure in the closed volume at the start of the pressure change, wherein t_{ch2} is a time constant of the second exponential change, wherein t_{ch2} is a duration of the second exponential change and wherein q_{gen} is the airflow generated by the pressure generator.

By use of the proposed method, the airflow resistance R can be measured at the very beginning of the exponential change and hence very fast. In case i) this means an almost zero measuring time. However, because the pressure difference Δp=0 in this case, advantageously this method may be used for measuring an estimated or preliminary value of the airflow resistance R.

In yet another advantageous embodiment, the airflow resistance R can be calculated by means of the formula

$$R = \frac{Δ p}{{q}_{gen}}$$

wherein the airflow q_{gen} is controlled by means of an airflow control and wherein a variation of the airflow q_{gen} is kept in a range of ±1% by means of the airflow control and a variation of the pressure difference Δp faded down to less than ±1% for use in the above formula or
wherein the pressure difference Δp is controlled by means of a pressure control and wherein a variation of the pressure difference Δp is kept in a range of ±1% by means of a pressure control and/or wherein a variation of the airflow q_{gen} faded down to less than ±1% for use in the above formula.

In this embodiment, the airflow resistance R is measured in a constant or quasi constant state of the test arrangement. In a first variant, an open loop or closed loop airflow control can be used to cause the pressure generator generating a constant airflow or constant volume changing rate. If a closed loop airflow control is used, an actual airflow is feed back to a summing point of the control loop and subtracted there from a target value for the airflow. The airflow control outputs a driving signal for pressure generator based on the result of this subtraction. In this first variant, a variation of Δp fades down to less than ±1% after 5·τ_{ch1} or 5·τ_{ch2} respectively. So, based on the constant airflow or constant volume changing rate and based on the size of the closed volume and the air flow resistance R, it may take a long time before the airflow resistance R can be calculated. To accelerate this process, in a second variant, a pressure control with a feedback loop can be used. Here, an actual pressure difference Δp is feed back to a summing point of the control loop and subtracted there from a target value for the pressure difference Δp. The pressure control outputs a driving signal for pressure generator based on the result of this subtraction. Here, the airflow resistance R can be calculated as soon as the pressure difference Δp is kept in a range of ±1% by means of the pressure control and/or a variation of the airflow q_{gen} faded down to less than ±1%. Depending on the pressure control, the above conditions can be fulfilled very fast.

Generally, the airflow control and/or the pressure control can be embodied as a PID control (having a proportional, an integral and a differential part), a PI control (having a proportional and an integral part) or a PD control (having a proportional and a differential part) for example. They may be designed to asymptotically reach a target value or in a way that overshoot is allowed. Generally, the closed loop pressure control may also be used for any of the pressure changes disclosed herein. That means that the pressure change according to a ramp function, an exponential function, a sine function, a cosine function or a step function may be operated by the pressure control.

Furthermore it is advantageous if the airflow resistance R is calculated by means of the formula

$$R = \frac{tan ( φ )}{2 π f C}$$

wherein f is a frequency of a sinusoidal airflow q_{gen}, wherein o is a phase shift between the sinusoidal airflow q_{gen} and the pressure difference Δp, wherein C=V_{shf}/(p₀−pₑₓₜ) is a pressurized air capacity of the closed volume, wherein V_{shf} is the size of the volume shifted by the pressure generator and wherein p₀ is an actual or mean value of the internal pressure pᵢₙₜ. In this embodiment, a periodic airflow q_{gen} is generated by the pressure generator which causes a periodic pressure difference Δp. This pressure difference Δp is phase shifted in view of the periodic airflow q_{gen} and is a measure for the airflow resistance.

Advantageously, the internal pressure pᵢₙₜ is changed over time with a frequency lower than 25 Hz in the given context or in other words, the frequency f beneficially can be in a range lower than 25 Hz in the given context. This is particularly true for a typical alternating signal measuring case. However, in principle, the internal pressure pᵢₙₜ may also change over time in a typical constant signal measuring case. For example, the internal pressure pᵢₙₜ may comprise a high constant signal component and a low amplitude alternating signal component. Beneficially, the internal pressure pᵢₙₜ changes over time with a frequency lower than 0.5 Hz then.

For example, the internal pressure pᵢₙₜ can be changed from the external pressure pₑₓₜ to the internal pressure p₀ during a duration t_{ch1}′ of a first alternative first change from 0 to an change end time t_{end}, which is in a range from 100 ms to 2 s, according to
a ramp function pᵢₙₜ=pₑₓₜ+(p₀−pₑₓₜ)·t_{ch1}′/t_{end},
an exponential function pᵢₙₜ=p₀−(p₀−pₑₓₜ)·e^{-tch1′/τch1}′, wherein τ_{ch1}′ is a time constant of the exponential function, wherein p₀ is the limiting value of the internal pressure pᵢₙₜ after infinite duration t_{ch1}′ and wherein p₀<p₀,
a sine function pᵢₙₜ=pₑₓₜ+(p₀−pₑₓₜ)·sin (t_{ch1}′/t_{end}·90° or a cosine function pᵢₙₜ=pₑₓₜ+(p₀−pₑₓₜ)·0.5·(1−cos (t_{ch1}′/t_{end}·180°.

By these measures, a pressure change for a subsequent measurement of the airflow resistance R according to any of the aforementioned possibilities point ii) each can be done. In other words, this embodiment describes possibilities for a pressure change, which starts at a pressure difference Δp=0 and ends at a pressure difference Δp≠0, and a subsequent measurement of the airflow resistance during a second exponential change, which starts at a pressure difference Δp+0 and ends at a pressure difference Δp=0. By choosing a suitable function and suitable parameters, overshoot of the internal pressure and (strong) air turbulences can be avoided. The exponential function of this embodiment is quite similar to the aforementioned exponential functions of point i) each, but however, no airflow resistance R is measured during the first alternative first exponential change in this embodiment, but during the second exponential change.

In another embodiment the internal pressure pᵢₙₜ is changed from the external pressure pₑₓₜ to the internal pressure p₀′ in a range of a duration t_{ch1}″ of a second alternative first change from 10 ms to 100 ms according to a step function. By these measures, overshoot of the internal pressure and strong air turbulences shall be avoided, too. The above pressure change is considered to be a step function because of the very short time, in which the pressure change takes place. However, more strictly, the pressure change can also be considered to happen according to a fast ramp function, a fast exponential function, a fast sine function or a fast cosine function. Hence, the range of time t_{end} from 100 ms to 2 s in the aforementioned definition can also be set to 10 ms to 100 ms to obtain a quasi step function.

Advantageously, the pressure generator can generate
a single constant air flow or
different sequential constant air flows.

Generally, a constant air flow causes an exponential change of the internal pressure pᵢₙₜ unless the airflow resistance is infinite what causes a linear pressure change. The use of a constant air flow is of advantage because number of possibilities have been proposed to measure the airflow resistance R by use of an exponential pressure change. The second option is particularly useful if a usable air flow is not known beforehand but has to be found out during measurement. In this case, the test device switches from a less usable air flow to a better usable air flow during the measurement.

In a very advantageous embodiment of the proposed method and test device
the internal pressure pᵢₙₜ is changed by means of a first constant air flow q₁,
an estimated value of the airflow resistance Rₑₛₜ is calculated by any one of the methods

$$\begin{matrix}{R}_{est} = \frac{{τ}_{c h 1}}{C} \\ {R}_{est} = \frac{{τ}_{A 1}}{C} \\ {R}_{est} = \frac{1}{{q}_{1}} \cdot \frac{d {p}_{i n t}}{d t}\end{matrix}$$

wherein reference is made to the aforementioned methods to calculate the airflow resistance R, which are used herein to calculate an estimated value of the airflow resistance Rₑₛₜ instead,
the constant air flow is changed to q₂=Δp/Rₑₛₜ at a given value of the pressure difference Δp and
the airflow resistance R (i.e. its final measuring value) is calculated by means of the formula

$$R = \frac{Δ p}{{q}_{2}}$$

In this embodiment, two different measuring methods are combined, i.e. deriving an estimated value of the airflow resistance Rₑₛₜ by a first measuring method and deriving the (final value of the) airflow resistance R from an airflow q₂ into or out of the closed volume according to a second measuring method.

It should be noted that the final pressure in the above context does not need to be reached according to an exponential pressure change, but any other suitable method can be used to reach the final pressure once the estimated value of the airflow resistance Rₑₛₜ has been calculated. For example, a different (in particular faster) exponential change, a ramp function, a sine function, a cosine function or a step function as disclosed before can be used.

It should also be noted that the step of calculating an estimated value of the airflow resistance Rₑₛₜ may be omitted if the expected value of the airflow resistance R or a range of the expected value of the airflow resistance R is known before the measurement. In this case, simply the volume change rate or (virtual) airflow is switched from q₁ to q₂ at the final pressure. For example, the expected value of the airflow resistance R or the range of the expected value of the airflow resistance R may be known because the proposed measurement takes place in a production line of acoustic transducers, acoustic components for an acoustic transducers or materials for an acoustic components of acoustic transducers. Basically, a check is performed whether the produced goods fulfill nominal requirements in terms of the airflow resistance R.

The proposed embodiment works with and without pressure control. In an advantageous embodiment, the system is brought to a state where the internal pressure has reached its desired value and where the airflow q₂ is active before the pressure control is activated. So advantage is taken from the possibility of calculating an estimated value of the airflow resistance Rₑₛₜ and the closed loop pressure control. A proper set value can be calculated very fast with the estimated value of the airflow resistance Rₑₛₜ. The pressure control then is only used for fine tuning.

Advantageously,
a speaker is provided as the pressure generator, an actively deflectable membrane of which adjoins the closed volume and
said membrane, before changing an internal pressure by a deflection of the membrane in a first excitation direction, is deflected in a second opposite excitation direction starting from its idle position.

In other words, the membrane is deflected out of the closed volume before the internal pressure pᵢₙₜ for the measurement is increased and deflected into the closed volume before the internal pressure pᵢₙₜ for the measurement is decreased. By these measures, the total excitation of the membrane for compressing or decompressing the closed volume can be increased. This method may also be applied to a piston compressor but is particularly advantageous in the context of a speaker with comparably small total shifted volume.

In another advantageous embodiment, a movement or a deflection of a surface of the pressure generator, which surface adjoins the closed volume, for a second detection of the change of the measured pressure difference over time in case a) or of the airflow into or out of the closed volume in case b) starts from a position, which was reached for a preceding first detection. By the proposed measures, a back movement or back deflection of the surface of the pressure generator between detections according to cases a) or b) can be saved. Instead, a subsequent change of the internal pressure pᵢₙₜ starts from where a preceding change of the internal pressure pᵢₙₜ ended. If there is no possibility for moving or deflecting the surface of the pressure generator further in a first excitation direction, the excitation direction can be reversed, and said surface of the pressure generator can be moved or deflected in a second opposite excitation direction for one or more changes of the internal pressure. However, one should consider that the size of the closed volume changes during subsequent detections in this embodiment.

In yet another advantageous embodiment,
changing the internal pressure pᵢₙₜ by increasing the same in view of an external pressure pₑₓₜ for a first detection of the change of the measured pressure difference Δp over time in case a) or of the airflow q_{gen} into or out of the closed volume in case b) and
changing the internal pressure pᵢₙₜ by decreasing the same in view of an external pressure pₑₓₜ for a subsequent, second detection takes place in alternation.

As already said, the proposed method and test device both work with increasing or decreasing the internal pressure pᵢₙₜ in view of the external pressure pₑₓₜ. By the proposed measures, a movement or deflection of a surface of the pressure generator, which surface adjoins the closed volume, both in a first excitation direction and in a second opposite excitation direction can be used for a measurement. So, a back movement or back deflection of the surface of the pressure generator between detections according to case a) or b) can be saved. In other words, the proposed measures allow for a very fast sequence of subsequent detections and measurements. In addition, air turbulences when the pressure is equalized during a back movement or back deflection are avoided or at least substantially suppressed.

It is also of advantage, if the internal pressure pᵢₙₜ is changed to the external pressure pₑₓₜ by the pressure generator before a test object forming or comprising the enclosure is removed from the test device. That means that a movement or deflection of the pressure generator is reversed after the measurement. In this way, air turbulences when the pressure is equalized during taking off the test object from the test device can be avoided or at least substantially be suppressed.

Moreover, it is advantageous, if the test device additionally comprises a passive membrane, which is arranged in the test device housing and adjoins the closed volume. By these measures the size of the closed volume can virtually be increased. “Virtual volume increase” in this context particularly means that the size of the closed volume for the concerns of the measurement of the airflow resistance is increased although in fact it substantially stays the same. According to the gas equation, the following relation is true:

$$\frac{{p}_{2}}{{p}_{1}} = \frac{{V}_{1}}{{V}_{2}} = \frac{{V}_{1}}{{V}_{1} - Δ V}$$

wherein V₁ is the size of the closed volume at the pressure p₁, V₂ is the size of the closed volume at the pressure p₂, and AV is a volume change. The membrane, which is soft compared to the rigid enclosure, bends when an inflow into or outflow out of the closed volume is generated by the pressure generator. So, for the same pressure difference, a higher volume change AV as without the membrane is needed. This also means that for the same pressure ratio p₂/p₁, V₁ must “virtually” be increased in the above equation if a passive membrane is used.

In the above context, it is of advantage if the pressure sensor comprises a laser distance sensor, which is directed to the passive membrane and which is designed to measure a deflection thereof. In this way, the internal pressure pᵢₙₜ can be measured with the laser sensor. A further dedicated pressure sensor can be saved.

Advantageously, the passive membrane can have a size in a range of 0.4 to 25 cm² and a compliance in the region of 1 to 30 mm/N. In particular, the ranges are interlinked in a way that an increasing range for the size is interlinked with a decreasing range of the compliance. That means that the parameters size and compliance of the passive membrane particularly can range from 0.4 cm² and 30 mm/N to 25 cm² and 1 mm/N. Accordingly, a virtual increase of the size of the closed volume ranges from 6 cm³ (with a size and a compliance of the passive membrane of 0.4 cm² and 30 mm/N) to 625 cm³ (with a size and a compliance of the passive membrane of 25 cm² and 1 mm/N) can be achieved.

Beneficially, the test device additionally comprises a vent in the test device housing. In this way, the internal and external pressure can be equalized before starting the measurement. For this reason, the vent is opened and closed again before the pressure change caused by the pressure generator starts.

It is very advantageous if a maximum total linear extension of the closed volume is smaller than 12 cm. By the proposed measures, frequencies of eigenmodes of the closed volume can be kept higher than 500 Hz what is particularly beneficial for measuring the airflow resistance in the context of acoustic devices. The maximum total linear extension is measured from one end of the closed volume to the other end.

In another very advantageous embodiment, the closed volume comprises a plurality of elongated sections, wherein a variation of a cross sectional area of the elongated sections is in a range of ±30% of an average cross sectional area of the elongated sections. In that, on the one hand, comparably small volumes can be realized, on the other hand, necessary distances between necessary connections to the closed volume on the test device housing can be provided. For example, the pressure generator, the pressure sensor, an optional connector, an optional vent and an optional passive membrane have a particular size and hence cannot be arranged arbitrarily close to each other. Further on, the limited variation of the cross sectional areas of the elongated sections ensures that narrowings causing substantial unwanted echoes are avoided. The cross section of the elongated sections may have any desirable shape, for example a circular shape or polygonal shape. If the elongated sections have a circular shape, the closed volume at least partially may be formed by (interconnected) bores in the test device housing.

Further on it is advantageous if the test device additionally comprises volume changing means for changing a size of the closed volume, wherein the volume changing means are embodied as
a set of exchangeable housing parts, wherein one of the exchangeable housing parts can be connected to the test device housing each and then adjoins a part of the closed volume in a mounted position and wherein the part of the adjoined closed volume of the different housing parts is different,
at least one volume changing gate valve or vent, by which an additional volume can be connected to or disconnected from the closed volume, or
a volume changing piston, which adjoins the closed volume and which is movable by a volume changing actuator (e.g. by a spindle drive).

By the proposed measures, the size of the closed volume can be varied to adapt it to the range of the expected or measured airflow resistance. In particular, the closed volume can be enlarged to increase the resolution of the measurement, and the closed volume can be reduced to reduce the test time. For the second option, one should particularly note that there may be more than one additional volume and volume changing gate valve or vent, wherein the additional volumes and volume changing gate valves or vents may be arranged in series or in parallel. Moreover, for the third option one should note that the volume changing piston shall not be confused with the piston of the pressure generator, because the volume changing piston is not intended for generating the pressure difference Δp but for changing the size of the closed volume before the internal pressure pᵢₙₜ is changed for a measurement of the airflow resistance R. Usually, the volume changing piston is intended for a much higher volume change and usually is much slower than this is the case for the pressure generator.

In the above context it is furthermore advantageous if the test device additionally comprises a volume changing control,
which is adapted to keep a state of the volume changing means and the size of the closed volume the same during measurement of the airflow resistance or
which is adapted to monitor a state of the volume changing means and the size of the closed volume during measurement of the airflow resistance and to output an alert if said state and said size changes during measurement of the airflow resistance.

Generally, this embodiment allows for ensuring a valid measurement of the airflow resistance. For example, the aforementioned exchangeable housing parts can have an identification, which is linked to the part of the adjoined closed volume and which is read by the volume changing control. In this way, errors about the used housing part can be prevented, and a valid measurement of the airflow resistance can be ensured. The volume changing control alternatively or in addition may be adapted to keep a state of the volume changing means and the size of the closed volume the same during measurement of the airflow resistance. For example, the housing part may (actively) be locked to the test device during measurement. In case of the aforementioned changing gate valve or vent, the volume changing control can be provided for monitoring and/or locking the state of the volume changing gate valve or vent (open vs. closed). Finally, in case of the aforementioned volume changing piston, the volume changing control can be provided for monitoring and/or locking an excitation of the volume changing piston.

In another advantageous embodiment, the connector of the test device can comprise an inner flat sealing and an axially outer O-ring displaced thereof. In this context, furthermore it is of advantage if
the test object comprises a tube section with an outer collar with rounded or chamfered edges,
the end of the tube section compresses the inner flat sealing and the collar compresses the outer O-ring in the inserted condition and
the O-ring holds the test object back in the inserted condition without an external force.

In other words, a kind of an airtight snap-in connection is formed. The snap-in connection can be released again if the test object is pulled out of the connector with a force exceeding the hold back force generated by the O-ring. This kind of connector is particularly useful if the test object is formed by an in-ear headphone. Here the advantages of the comparably small pressure difference Δp of 1 Pa to 480 Pa are particularly evident, because on the one hand, it allows for simple inserting and removing the test object without the need of tools and on the other hand, for a fast testing method. Moreover, the comparably small pressure difference Δp does not form a risk for the in-ear headphone as such. That means that there is no risk that parts of the in-ear headphone break because of the pressure. All in all, the proposed connector is particularly useful in a high speed production line of in-ear headphones with short cycle times.

In yet another advantageous embodiment, the connector can comprise an additional outer flat sealing which is arranged axially out of the outer O-ring and which is displaced thereof. The additional outer flat sealing in the inserted condition closes an aperture or mesh of the test object. So, airtightness of the test object can be measured, even if the test object housing comprises an aperture or mesh. Such an aperture or mesh in case of in-ear headphones may allow pressure equalization when the in-ear headphones are inserted into the ear canal of a user and may allow for noticing sound in the environment of the user.

It should be noted at this point that the technical disclosure of the dependent claims each or in any combination (in particular in any combination as defined by the back references in the claims) without the features of the independent claims or at least without the characterizing features of the independent claims may form the basis for an independent claim. In particular, a dependent claim may replace the characterizing features of an independent claim. So, for example, claim 23 alone or in combination with claim 24 may form the basis for an independent claim without the characterizing features of the independent claim related to the test device. For example, such a claim may be phrased as follows:

Test device for measuring an airflow resistance of an enclosure of a closed volume (in particular of an aperture or a mesh being arranged in the enclosure and adjoining the closed volume), comprising
a test device housing, which at least partly encloses the closed volume,
a pressure generator, which is connected to the test device housing and which is provided to change an internal pressure within the closed volume in view of an external pressure in the environment of the closed volume,
a pressure sensor, which is designed to measure a pressure difference between the internal pressure and the external pressure, and
an evaluation circuit, which is designed a) to detect a change of said measured pressure difference over time and to derive the airflow resistance thereof and/or b) to detect an airflow into or out of the closed volume generated by the pressure generator or a volume change rate of the closed volume generated by the pressure generator and to derive the airflow resistance thereof,
wherein the pressure generator comprises a surface being movable or deflectable in a controlled manner, wherein the surface adjoins the closed volume, and wherein in particular the pressure generator is designed as a piston compressor and wherein the movable surface is formed by a surface of a piston of the piston compressor.

It is expressively noted that the above claim is just exemplary and may not construed as limiting the possibilities for making other independent claims. Nevertheless, without prejudice the technical disclosure of claims 3-7, 12, 24, 25, 31, 32 and 40-41 is considered to be particularly relevant for forming one or more independent claims without the features or at least without the characterizing features of the independent claims of this disclosure. It is also noted that the dependent claims of this disclosure may form new dependent claims of such a new independent claim.

### BRIEF DESCRIPTION OF THE DRAWINGS

These and other aspects, features, details, utilities, and advantages of the invention will become more fully apparent from the following detailed description, appended claims, and accompanying drawings, wherein the drawings illustrate features in accordance with exemplary embodiments of the invention, and wherein:

FIG. 1 shows a schematic cross sectional view of a first example of a test arrangement;

FIG. 2 shows a diagram of the absolute value of the internal pressure over time for an embodiment, where the measurement is done at the end of a first exponential pressure change;

FIG. 3 shows a diagram of the absolute value of the internal pressure over time, where the measurement is done during a second exponential pressure change;

FIG. 4 similar to FIG. 3 but where the airflow resistance is calculated by means of a second approximated internal pressure;

FIG. 5 similar to FIG. 2 but where two different volume change rates or airflows are used for measuring the airflow resistance;

FIG. 6 similar to FIG. 5 but where less usable volume change rates or airflows are chosen in a first attempt;

FIG. 7 shows a schematic picture of an exemplary closed loop control;

FIG. 8 shows a possible graph of the internal pressure when using a closed loop pressure control;

FIG. 9 shows a graph of the absolute value of a sinusoidal internal pressure and a sinusoidal volume change rate or airflow over time;

FIG. 10 shows a test arrangement with a passive membrane in the test device housing and a laser distance sensor directed to the same;

FIG. 11 shows a test arrangement, where the pressure generator is embodied as a speaker;

FIG. 12 shows a schematic cross sectional view of an exemplary speaker, which at the same time forms the test device;

FIG. 13 shows a cross sectional view of an advantageous connector for connecting a test object to the test device;

FIG. 14 shows a test arrangement with volume changing means, which are embodied as a set of exchangeable housing parts;

FIG. 15 shows a test arrangement with volume changing means, which comprise at least one volume changing gate valve or vent;

FIG. 16 shows a test arrangement with volume changing means, which comprise a volume changing piston; and

FIG. 17 shows a schematic angular view of a test arrangement, where the closed volume comprises a plurality of elongated sections.

Like reference numbers refer to like or equivalent parts in the several views.

### DETAILED DESCRIPTION OF EMBODIMENTS

Various embodiments are described herein to various apparatuses. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It must be noted that, as used in this specification and the appended claims, the singular forms “a,” “an” and “the” include plural referents unless the content clearly dictates otherwise.

The terms “first,” “second,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

All directional references (e.g., “plus,” “minus,” “upper,” “lower,” “upward,” “downward,” “left,” “right,” “leftward,” “rightward,” “front,” “rear,” “top,” “bottom,” “over,” “under,” “above,” “below,” “vertical,” “horizontal,” “clockwise,” and “counterclockwise”) are only used for identification purposes to aid the reader's understanding of the present disclosure, and do not create limitations, particularly as to the position, orientation, or use of the any aspect of the disclosure. It is to be understood that the terms so used are interchangeable under appropriate circumstances such that the embodiments of the invention described herein are, for example, capable of operation in other orientations than those illustrated or otherwise described herein.

As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose.

Joinder references (e.g., “attached,” “coupled,” “connected,” and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims. Nevertheless, the term “connected” within the disclosure in particular can mean “direct connection” (without intermediate parts), and the term “couple” within the disclosure in particular can mean “direct or indirect connection” (with or without intermediate parts).

All numbers expressing measurements and so forth used in the specification and claims are to be understood as being modified in all instances by the term “about” or “substantially,” which particularly means a deviation of +10% from a reference value.

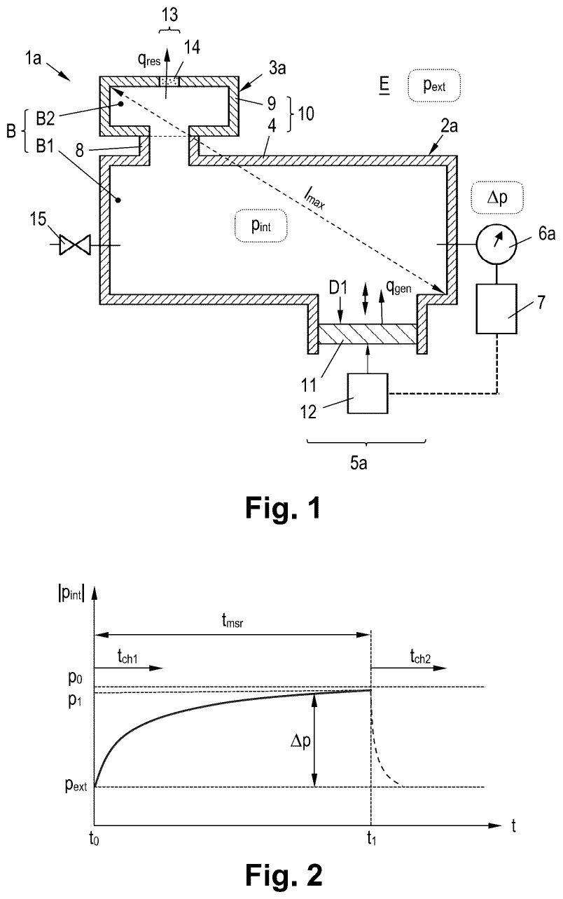

FIG. 1 shows a schematic cross sectional view of a first example of a test arrangement 1a, which comprises a test device 2a and a test object 3a.

The test device 2a comprises a test device housing 4, which encloses a test device housing volume B1, a pressure generator 5a, which is connected to the test device housing 4, a pressure sensor 6a, an evaluation circuit 7 and an optional connector 8, which is arranged in the test device housing 4 and by which the test object 3a is connected to the test device 2a. The test object 3a inter alia comprises a test object housing 9, which encloses a test object housing volume B2. The test device housing 4 and the test object housing 9 together form an enclosure 10 of a closed volume B, which is the sum of the test device housing volume B1 and the test object housing volume B2. In other words, the test device housing 4 and the test object housing 9 together encompass the closed volume B.

The pressure generator 5a is provided to change an internal pressure pᵢₙₜ within the closed volume B in view of an external pressure pₑₓₜ in the environment E of the closed volume B. In this particular example, the pressure generator 5a is designed as a piston compressor 5a with a piston 11 and a pressure generator actuator 12 connected thereto. By means of the pressure generator actuator 12, the piston 11 can be moved upwards and downwards. For example, the pressure generator actuator 12 may be designed as a rotational motor connected to a crank shaft, wherein a connecting rod is arranged between the piston 11 and the crank shaft. In an other embodiment, the pressure generator actuator 12 may be formed by a linear motor like a spindle drive or a pneumatic or hydraulic cylinder.

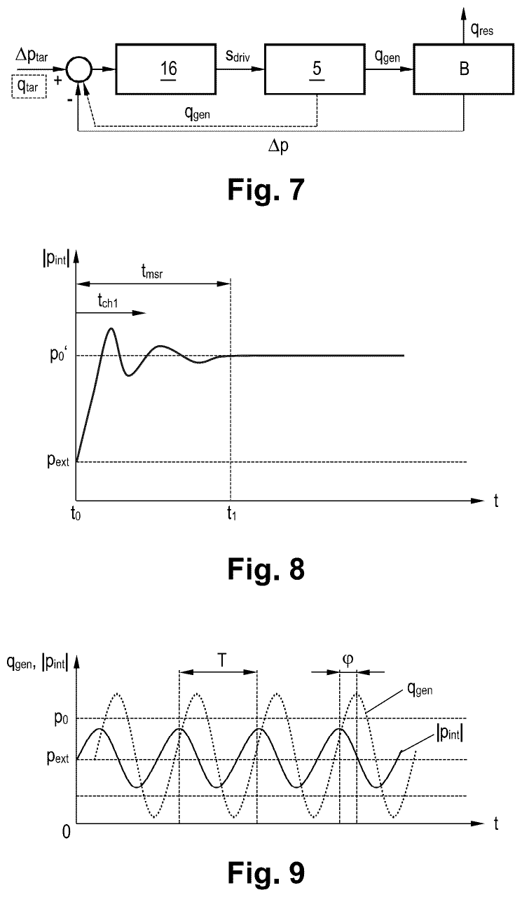

In general, the pressure generator 5a comprises a surface D1, which adjoins the closed volume B. That particularly means that there is no compressed air line coming from a compressor, but the test device housing volume B1 can be compared to the cylinder volume of a standard compressor. Due to this design, there are no or just minor air turbulences in the closed volume B during a pressure change. In particular, a pressure change for a (single) measurement is accomplished by moving the piston 11 in just one direction (instead of a forth and back movement of the piston in a cylinder with valves like it is the case with a standard compressor with a compressed air line). The piston 11 is movable in a controlled manner. That means that the pressure generator actuator 12 does not freely move but is connected to or comprises an open or closed loop (airflow or pressure) control to control the movement or excitation of the piston 11 (see also FIG. 7 in this context).

The test object housing 9 comprises an optional aperture 13 with an optional mesh 14. Accordingly, the aperture 13 and the mesh 14 are arranged in the enclosure 10 and adjoin the closed volume B. For example, the test object 3a can be formed by an acoustic transducer (e.g. a microphone, a speaker or a headphone). Moreover, the test object 3a can be formed by an acoustic component for an acoustic transducer (e.g. a membrane or equalization means like the mesh 14) or can even be simply a material for an acoustic component of an acoustic transducer (e.g. a membrane material, a damping foam, a porous material or a mesh material). If so, the test object housing 9 can be seen as a carrier for the acoustic component or the material for the acoustic component.

If the internal pressure pᵢₙₜ is changed by the pressure generator 5a (i.e. by a movement of its piston 11), an airflow qᵣₑₛ through the aperture 13 or the mesh 14 respectively is caused. In the example of FIG. 1, the airflow qᵣₑₛ points out of the closed volume B what means that the internal pressure pᵢₙₜ is increased over the external pressure pₑₓₜ causing a positive pressure difference Δp. However, the test arrangement 1a also works if the piston 11 is retracted thereby decreasing the internal pressure pᵢₙₜ below the external pressure pₑₓₜ and causing a negative pressure difference Δp. The airflow qᵣₑₛ points into the closed volume B then.

Generally, the test device 2a is provided for measuring an airflow resistance of the enclosure 10 of the closed volume B. In this particular example this means that the airflow resistance of the aperture 13 and the mesh 14 shall be measured. For this reason, the pressure sensor 6a is designed to measure a pressure difference Δp between the internal pressure pᵢₙₜ and the external pressure pest. The pressure sensor 6a is illustrated as a simple gauge in FIG. 1. However, of course the pressure sensor 6a may particularly be designed as an electronic device, which otherwise than depicted does not necessarily have an instrument indicator.

The evaluation circuit 7 is designed to detect a change of said measured pressure difference Δp over time t and to derive the airflow resistance thereof (case a). Alternatively or in addition, the evaluation circuit 7 can be designed to detect an airflow q_{gen} into or out of the closed volume B or a volume change rate of the closed volume B generated by the pressure generator 5a and to derive the airflow resistance thereof (case b). For this reason, the evaluation circuit 7 can be connected to the pressure generator 5a what is indicated with the dashed line in FIG. 1. For example, the volume change rate can be derived from a speed of the piston 11, which is its excitation over time. For this reason, a position sensor of the piston 11 or of the pressure generator actuator 12 can be used. The volume change rate can also be derived from a control signal, which is fed into the pressure generator actuator 12 and which indicates a target excitation. So in other words, both an actual excitation or a target excitation may be used for detecting or calculating the volume change rate. In the same way, the (total) volume change or (total) shifted volume V_{shf} caused by the pressure generator 5a can be calculated, which in this case is the area of the piston 11 multiplied by its (total) excitation or the time integral of the volume change rate.

In this context, it should be noted that the volume change rate in the example of FIG. 1 can also be considered as a (virtual) airflow q_{gen} into or out of the closed volume B. Strictly speaking, the size of the closed volume B changes over time in the given example. Hence, in a first embodiment, the actual size of the closed volume B can be used in equations for measuring the airflow resistance R. However, if the volume change caused by the by the pressure generator 5a is small compared to the size of the closed volume B, the latter can be considered to be constant and set to an initial value, an end value or an average value. The very same counts for the (total) volume change, which can be considered as a (total) shifted volume V_{shf}.

It should also be noted that the test arrangement 1a otherwise than depicted may comprise a pressure generator 5a, which generates a real airflow q_{gen} into or out of the closed volume B, in particular without changing the size of the closed volume B. In the following disclosure, a real airflow q_{gen} and a virtual airflow q_{gen} (corresponding to the volume change rate) are synonymously meant by the simple term “airflow q_{gen}” without explicitly denoting whether the air airflow q_{gen} is real or virtual.

Finally, test arrangement 1a comprises a vent 15 in the test device housing 4, which is provided for equalizing the internal pressure pᵢₙₜ and the external pressure pₑₓₜ, i. e. bringing the pressure difference Δp to zero, before starting the measurement.

In general, a size of the closed volume B is in a range of 2 cm³ to 40 cm³, and the pressure difference Δp is in a range of 1 Pa to 480 Pa. The proposed ranges for the size of the closed volume B and the pressure difference Δp are particularly advantageous in the context of measuring airflow resistances R of acoustic components like speakers, headphones, and so on. More particularly, the proposed ranges allow for fast measuring sequences and reliable measuring values without risking a damage of the tested acoustic components by applying to much pressure.

The proposed ranges for the size of the closed volume B and the pressure difference Δp are also particularly useful if the airflow resistance is in a range of 20·10⁶ Pa·s/m³ to 300·10⁹ Pa·s/m³ or in a range of 20 Acoustic MOhm to 300 Acoustic GOhm respectively. In other words, the proposed method, the proposed test device and the proposed test arrangement are particularly suitable for measuring an airflow resistance in the given range. In this range, the advantages mentioned before are particularly evident.

By the proposed measures, generally, an airflow resistance of an enclosure 10 of a closed volume B can be measured. So, on the one hand, an airflow resistance of, for example, an aperture 13 or a mesh 14 being arranged in the enclosure 10 and adjoining the closed volume B can be measured. However, on the other hand, the proposed measures may also be used for checking or testing an airtightness of the enclosure 10, which for example may be formed by a housing 4 of a test device 2a and/or a housing 9 of a test object 3a.

In an advantageous embodiment, the measured airflow resistance is qualified as infinite if it is larger than 300·10⁹ Pa·s/m³ or 300 Acoustic GOhm respectively. Accordingly, a test device housing 4 and/or a test object housing 9 is qualified as airtight above the given threshold value of the measured airflow resistance R.

As this is the case in the example of FIG. 1, the proposed method may comprise the step of connecting a test object 3a to the test device 2a before the internal pressure pᵢₙₜ is changed.

As already noted, the proposed method both applies to increasing or decreasing the internal pressure pᵢₙₜ within the closed volume B in view of an external pressure pₑₓₜ. However, measurements with increased and decreased internal pressure pᵢₙₜ may lead to different results of the airflow resistance R as the case may be. A reason may be a non-symmetric aperture 13 in the enclosure 10 causing different flow conditions for inflow into and outflow from the closed volume B.

Beneficially, a maximum total linear extension Imax of the closed volume B is smaller than 12 cm. In this way, frequencies of eigenmodes of the closed volume B can be kept higher than 500 Hz what is particularly beneficial for measuring the airflow resistance R in the context of acoustic devices. The maximum total linear extension Imax is measured from one end of the closed volume B to the other end.

For measuring the airflow resistance R a couple of measuring methods are proposed, which are disclosed in more detail hereinafter.

In general, the method for measuring the airflow resistance comprises the following steps:
changing the internal pressure pᵢₙₜ within the closed volume B in view of the external pressure pₑₓₜ in the environment E of the closed volume B by the pressure generator 5a,
measuring the pressure difference Δp between the internal pressure pᵢₙₜ and the external pressure pₑₓₜ by the pressure sensor 6a and
a) detecting the change of said measured pressure difference Δp over time t and deriving the airflow resistance thereof by the evaluation circuit 7 and/or b) detecting the airflow q_{gen} into or out of the closed volume B or the volume change rate of the closed volume B generated by the pressure generator 5a and deriving the airflow resistance thereof by the evaluation circuit 7.

FIG. 2 now shows a diagram of the absolute value of the internal pressure pᵢₙₜ over time t. In a first step, the internal pressure pᵢₙₜ is changed within the closed volume B in view of the external pressure pₑₓₜ by the pressure generator 5a as explained hereinbefore. However, the internal pressure pᵢₙₜ and the external pressure pest, can be equalized before by means of the vent 15 as the case may be.

In the example of FIG. 2, the volume change rate or the (virtual) airflow q_{gen} into or out of the closed volume B is kept constant what can be achieved by moving the piston 11 with constant speed. For this reason, an open loop airflow control or closed loop airflow control may be used (see also FIG. 7 in this context). In this example, the constant airflow q_{gen} causes an exponential change of the internal pressure pᵢₙₜ, which approaches a limiting value p₀ and reaches the same after infinite duration. In other words, the pressure difference Δp is constant after infinite time or quasi constant after a sufficient period of time. More mathematically, the internal pressure pᵢₙₜ changes according to the function pᵢₙₜ=p₀−(p₀−pₑₓₜ)·e^{-tch1/τch1}, wherein τ_{ch1} is a time constant of the first exponential change, which starts at to at a pressure difference Δp=0, wherein τ_{ch1} is a duration of the first exponential change and wherein p₀ is the limiting value of the internal pressure pᵢₙₜ in the closed volume B after infinite duration t_{ch1}. In this example, the airflow resistance R can be calculated by means of the formula

$$R = \frac{Δ p}{{q}_{gen}}$$

wherein a variation of Δp faded down to less than ±1% for use in the above formula. In general, the above condition is true after t_{ch1}=5. τ_{ch1}. In this example, the pressure Δp=p₁−pₑₓₜ at a measuring time point t₁ and the airflow q_{gen} generated by the pressure generator 5a are used to calculate the airflow resistance R. Advantage is taken from the fact here that the airflow qᵣₑₛ through the aperture 13 and the mesh 14 equals the airflow q_{gen} generated by the pressure generator 5a when the pressure difference Δp is constant or quasi constant. After the measuring time tₘₛᵣ, which corresponds to the measuring time point t₁ in this example, the internal pressure pᵢₙₜ is changed according to a second exponential change during a time t_{ch2}. For example, the piston 11 can be moved into its idle position or the vent 15 can be opened for that reason. It is also possible to simply remove the test object 3a from the test device 2a.

The diagram of FIG. 2 shows the absolute value of the internal pressure pᵢₙₜ over the time t and hence is valid for both increasing the internal pressure pᵢₙₜ over the external pressure pₑₓₜ by an inward movement of the piston 11 and for decreasing the internal pressure pᵢₙₜ below the external pressure pₑₓₜ by an outward movement of the piston 11.

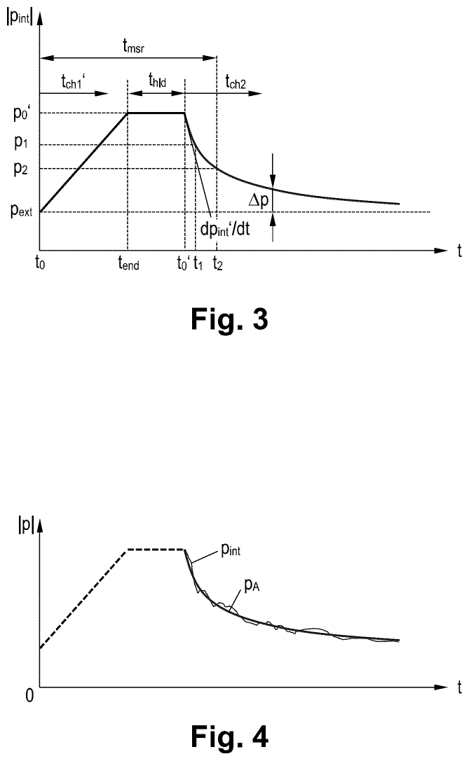

FIG. 3 now shows a diagram of the absolute value of the internal pressure pᵢₙₜ over time t for another example of measuring the airflow resistance R. In this example, the internal pressure pᵢₙₜ is changed from the external pressure pₑₓₜ to the internal pressure p₀ during a duration t_{ch1}′ of a change from 0 to a change end time t_{end} according to a ramp function pᵢₙₜ=pₑₓₜ+(p₀−pₑₓₜ)·t_{ch1}′/t_{end}. Then, an optional hold time thia follows, where the internal pressure pᵢₙₜ is constant. Finally, the piston 11 is stopped what leads to a second exponential change of the internal pressure

pᵢₙₜ=p₀′·e^{-tch2/τ}_{ch2} in the closed volume B starting at Δp≠0, wherein τ_{ch2} is a time constant of the second exponential change, wherein p₀′ is the internal pressure in the closed volume B at the start of the pressure change and wherein t_{ch2} is a duration of the second exponential change.

In one embodiment, the airflow resistance R is calculated by means of the formula

$$R = \frac{{τ}_{c h 2}}{C}$$

wherein C=V_{shf}/(p₀′−pₑₓₜ) is a pressurized air capacity of the closed volume B and wherein V_{shf} is the size of the volume shifted by the pressure generator 5a at the duration t_{ch2}. To measure the time constant τ_{ch2}, for example, the pressure p₁ and p₂ can be measured at two time points t₁ and t₂, wherein the following formula is used:

$${τ}_{c h 2} = - \frac{{t}_{2} - {t}_{1}}{\frac{log {p}_{2}}{{p}_{1}}}$$

Of course, the time constant τ_{ch2} alternatively or in addition may be calculated by

$${τ}_{ch 2} = - \frac{{t}_{ch 2}}{\frac{log {p}_{1}}{{p}_{0}^{′}}}$$

$$or$$

$${τ}_{ch 2} = - \frac{{t}_{ch 2}}{\frac{log {p}_{2}}{{p}_{0}^{′}}}$$

The measuring time tₘₛᵣ in the above examples corresponds to the measuring point t₂ or t₁. In another embodiment, the airflow resistance R can be calculated by means of the formula

$$R = \frac{1}{{q}_{gen}} \cdot \frac{{dp}_{int}^{′}}{dt}$$

wherein dpᵢₙₜ′/dt is the time gradient of a second exponential change of the internal pressure pᵢₙₜ=p₀′·e^{-tch2/τ}_{ch2} in the closed volume B at t_{ch2}=0. The measuring time tₘₛᵣ in this example corresponds to the measuring point to′.

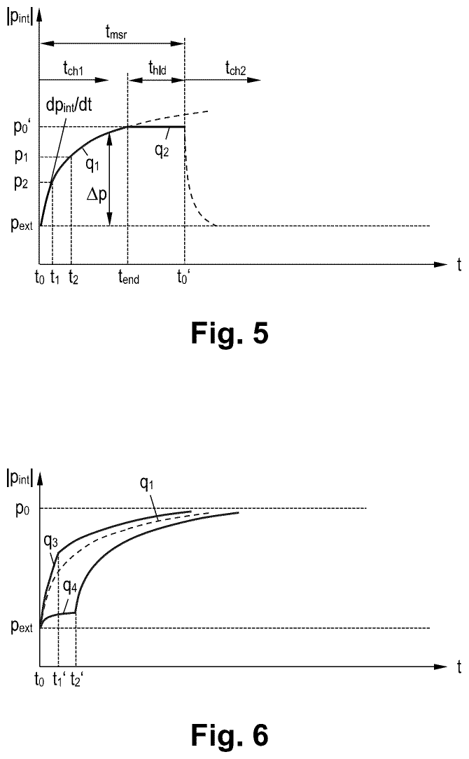

One should note that also the time gradient of a first exponential change of the internal pressure pᵢₙₜ=p₀−(p₀−pₑₓₜ)·e^{-tch1/tch1} may be used to calculate the airflow resistance R by reference to FIG. 5 and by means of the formula

$$R = \frac{1}{{q}_{gen}} \cdot \frac{{dp}_{int}}{dt}$$

It is noted at this point that a change of the internal pressure pᵢₙₜ according to a ramp function indicates airtightness if a constant airflow q_{gen} is used.

It should also be noted that changing the internal pressure pᵢₙₜ according to a ramp function is no necessary condition, and it can also be changed according to other function. For example, the internal pressure pᵢₙₜ alternatively can also be changed according to
an exponential function pᵢₙₜ=p₀−(p₀−pₑₓₜ)·e^{-tch1′/τch1}, wherein t_{ch1}′ is a time constant of the exponential function, wherein p₀ is the limiting value of the internal pressure pᵢₙₜ after infinite duration t_{ch1}′ and wherein p₀′<p₀,
a sine function pᵢₙₜ=pₑₓₜ+(p₀−pₑₓₜ)·sin (t_{ch1}′/t_{end}·90° or
a cosine function pᵢₙₜ=pₑₓₜ+(p₀−pₑₓₜ)·0.5·(1−cos (t_{ch1}′/t_{end}·180°.

Beneficially, the end time t_{end} is in a range from 100 ms to 2 s. By the proposed measures, overshoot of the internal pressure can be avoided. The proposed exponential function is quite similar to the exponential function of FIG. 2. However, no airflow resistance R is measured during the first exponential change, but during the second exponential change.

One should also note that a step function may be used to reach the pressure p₀′. In particular, the step function may have a duration of 10 ms to 100 ms. Because the real duration of the step function is unequal zero, such a pressure change can also be considered to happen according to a fast ramp function, a fast exponential function, a fast sine function or a fast cosine function where the range of time t_{end} from 100 ms to 2 s in the aforementioned definition is set to 10 ms to 100 ms to obtain a quasi step function.

Generally, both τ_{ch1} and t_{ch2} denote time spans of a pressure change. t_{ch1} denotes the time of a pressure change from the external pressure pₑₓₜ to a different internal pressure pᵢₙₜ, and t_{ch2} denotes the time of a pressure change to the external pressure pₑₓₜ beginning at a different internal pressure pᵢₙₜ. In case that the internal pressure pᵢₙₜ is increased over the external pressure pₑₓₜ, τ_{ch1} can be seen as rise time and t_{ch2} can be seen as drop time. If the internal pressure pᵢₙₜ is decreased in view of the external pressure pₑₓₜ, τ_{ch1} can be seen as drop time and t_{ch2} can be seen as rise time.

In the FIGS., both to and to′ denote time points when a pressure change starts. t₀ denotes the time point when the first exponential change from pᵢₙₜ=pₑₓₜ to a different internal pressure pᵢₙₜ starts, and to′ denotes the time point when the second exponential change ending at pᵢₙₜ=pₑₓₜ and beginning at a different internal pressure pᵢₙₜ starts.

Finally, it is noted that the size V_{shf} of the volume shifted by the pressure generator 5a at or until the duration τ_{ch1} can also be seen as the time integral of the airflow q_{gen} generated by the pressure generator 5a.

FIG. 4 now shows an embodiment, which is similar to that shown in FIG. 3 but where the airflow resistance R is calculated by means of a second approximated internal pressure p_{A2}=p₀′·e^{-tch2/τA2}, which is approximated to a real internal pressure pᵢₙₜ=p₀′·e^{-tch2/tch2}, wherein τ_{A2} is a time constant of an exponential change of the second approximated internal pressure p_{A2}. Generally, disturbances causing fluctuations of or noise in a measured (real) internal pressure pᵢₙₜ in the closed volume B can distort the pressure measurement and thus the calculation of the airflow resistance R. However, by approximating the internal pressure pᵢₙₜ, the calculation of the airflow resistance R can be made more resistant against disturbances and noise. For the approximation, in particular, a least mean square algorithm can be used.

FIG. 5 shows yet another embodiment, which is similar to that of FIG. 2. In contrast, two different volume change rates or (virtual) airflows q₁ and q₂ are used for measuring the airflow resistance R. Again, an open loop airflow control or closed loop airflow control may be used to obtain the constant airflows q₁ and q₂. In a first step, the volume change rate q₁ again causes a change of the internal pressure pᵢₙₜ according to the function pᵢₙₜ=p₀−(p₀−pₑₓₜ)·e^{-tch1/tch1}. During this change, an estimated value of the airflow resistance Rₑₛₜ is calculated by any one of the methods

$${R}_{est} = \frac{{τ}_{ch 1}}{C}$$

$${R}_{est} = \frac{{τ}_{A 1}}{C}$$

$${R}_{est} = \frac{1}{{q}_{1}} \cdot \frac{{dp}_{int}}{dt}$$

wherein τ_{A1} is a time constant of an exponential change of the first approximated internal pressure p_{A1}=p₀−(p₀−pₑₓₜ)·e^{-τ}^{_{ch1}}^{/τ}^{_{A1}}, wherein C=V_{shf}/(p₀−pₑₓₜ) again is a pressurized air capacity of the closed volume B and wherein V_{shf} again is the size of the volume shifted by the pressure generator 5a at the duration t_{ch1}.

In a next step, the constant air flow q_{gen} is changed to q₂=Δp/Rₑₛₜ at a given value of the pressure difference Δp, which is p₀′−pₑₓₜ in this example. If the approximation is correct, the internal pressure pᵢₙₜ stays constant during a hold time t_{hld}. If not, it again changes according to an exponential function, which however is much flatter than the one shown in FIG. 5. So, the condition that a variation of Δp sufficiently fades down, in particular to less than ±1%, can be fulfilled much faster than in the example of FIG. 2 what substantially shortens the measuring time tₘₛᵣ. The (final) value of the airflow resistance R then is calculated by means of the formula

$$R = \frac{Δ p}{{q}_{2}}$$

It should be noted that the pressure p₀′ does not need to be reached according to an exponential pressure change, but any other suitable method can be used to reach the pressure p₀′ once the estimated value of the airflow resistance Rₑₛₜ has been calculated. For example, a different (in particular faster) exponential change, a ramp function, a sine function, a cosine function or a step function as disclosed before can be used.

It should also be noted that the step of calculating an estimated value of the airflow resistance Rₑₛₜ may be omitted if the expected value of the airflow resistance R or a range of the expected value of the airflow resistance R is known before the measurement. In this case, simply the volume change rate or (virtual) airflow is switched from q₁ to q₂ at the pressure p₀′. For example, the expected value of the airflow resistance R or the range of the expected value of the airflow resistance R may be known because the proposed measurement takes place in a production line of acoustic transducers, acoustic components for an acoustic transducers or materials for an acoustic components of acoustic transducers. Basically, a check is performed whether the produced goods fulfill nominal requirements in terms of the airflow resistance R.

If the expected value of the airflow resistance R or the range of the expected value of the airflow resistance R is not known before the measurement, the chosen volume change rate or airflow q_{gen} generated by the pressure generator 5a may be too high or too low. FIG. 6 in this context shows an embodiment where the chosen volume change rate or airflow q₃ is too high and the internal pressure pᵢₙₜ rises too fast for a proper measurement of the airflow resistance R. On the other hand, the chosen volume change rate or airflow q₄ is too low and a considerable change of the internal pressure pᵢₙₜ takes too long for a measurement of the airflow resistance R. In such a case, the approximated airflow resistance Rₑₛₜ, which can be calculated as outlined before, can be used to switch to a proper volume change rate airflow q_{gen}, e.g. t₀ the airflow q₁, at the time t1′ or t2′ respectively.

Concluding, the pressure generator can generate a single constant air flow q_{gen} (see FIG. 2) or different sequential constant air flows q₁ . . . q₄ (see FIGS. 5 and 6).

One should also note that if no two step measurement is used as explained above, also a (final) value of the airflow resistance R can be calculated by the formulas

$$R = \frac{{τ}_{ch 1}}{C}$$

$$R = \frac{{τ}_{A 1}}{C}$$

$$R = \frac{1}{{q}_{1}} \cdot \frac{{dp}_{int}}{dt}$$

Generally, an open loop control may be used to provide a change of the internal pressure pᵢₙₜ. For example, the movement of the piston 11 may be controlled by an open loop control for that reason. However, in a beneficial embodiment, a closed loop control can be used instead. FIG. 7 in this context shows a schematic picture of an exemplary closed loop control, in detail a closed loop pressure control in solid lines and a closed loop airflow control in dashed lines.

First, the closed loop pressure control is explained. The closed loop comprises a summing point, a pressure control 16, the pressure generator 5 and the closed volume B. The pressure control 16 outputs a driving signal s_{driv} for pressure generator 5, which causes a movement of the pressure generator actuator 12 and thus of the piston 11. If the pressure generator actuator 12 is an electric motor, the driving signal s_{driv} for example may be voltage applied to that motor. In turn, a volume change rate or (virtual) airflow q_{gen} is caused. At the same time, there is an air flow qᵣₑₛ through aperture 13 or mesh 14. This results in a pressure difference Δp, which is feed back to the summing point and subtracted from the target value Δpₜₐᵣ of the pressure difference Δp.

By use of the pressure control 16, simply a suitable target value Δpₜₐᵣ for the pressure difference Δp can be set. FIG. 8 in this context shows a possible graph of the internal pressure pᵢₙₜ, where Δpₜₐᵣ=p₀′ and where a stable situation or quasi stable situation is reached at t₁. At t₁, the airflow resistance R again can be calculated by means of the formula

$$R = \frac{Δ p}{{q}_{gen}}$$

A variation of the pressure difference Δp shall be kept in a range of ±1% by means of the pressure control 16 and/or a variation of the airflow q_{gen} shall have faded down to less than ±1% for use in the above formula and to guarantee stable or quasi stable conditions.

As is visible in FIG. 8, the internal pressure pᵢₙₜ overshoots what may be unwanted under certain circumstances. However, the pressure control 16 may also be designed in a way that there is no overshoot and the internal pressure pᵢₙₜ reaches p₀′ asymptotically.

It should also be noted that that the operation of the pressure control 16 does not necessarily start at pᵢₙₜ=pₑₓₜ but it may also be used in the context of the embodiment illustrated in FIG. 5. For example, the volume change rate or (virtual) airflow q₂ can be calculated and set as outlined for FIG. 5. However, as already noted there, the estimated value of the airflow resistance Rₑₛₜ is just a guess and so is the volume change rate or airflow q₂. In an advantageous embodiment, the system is brought to a state where the internal pressure pᵢₙₜ=p₀′ and where the airflow q_{gen}=q₂ before the pressure control 16 is activated. So advantage is taken from the possibility of calculating an estimated value of the airflow resistance Rₑₛₜ combined with the closed loop control. In particular, if the internal pressure pᵢₙₜ=p₀′ is reached very fast, for example by a step function or a fast function of the kinds presented hereinbefore, a constant situation can be reached even faster than with starting the pressure control 16 at pᵢₙₜ=Pest.

Generally, the closed loop pressure control may be used for any of the aforementioned pressure changes. That means that the pressure change according to a ramp function, an exponential function, a sine function, a cosine function or a step function may be operated by the pressure control 16.

FIG. 7 in dashed lines additionally shows a closed loop airflow control. In this case, the control 16 is an airflow control, and an airflow q_{gen} is feed back to the summing point and subtracted there from the target value qₜₐᵣ of the airflow q_{gen}.

Generally, the pressure control 16 (or an airflow control) can be embodied as a PID control (having a proportional, an integral and a differential part), a PI control (having a proportional and an integral part) or a PD control (having a proportional and a differential part) for example.

In the aforementioned examples there was no periodic change of the internal pressure pᵢₙₜ. Nevertheless, there may be such a periodic change, which beneficially is “slow” what in the given context means that the internal pressure pᵢₙₜ is changed over time with a frequency lower than 0.5 Hz. However, a periodic change of the internal pressure pᵢₙₜ may knowingly or intentionally be utilized. FIG. 9 in this context shows a graph of the absolute value of the internal pressure pᵢₙₜ and the volume change rate or (virtual) airflow q_{gen} over time t. As can be seen, the volume change rate or airflow q_{gen} periodically changes over time t according to a sine function and so does the internal pressure pᵢₙₜ. In detail, the internal pressure pᵢₙₜ oscillates between an upper and a lower value around the external pressure pest, wherein neither the positive limiting value p₀, nor the negative limiting value is (ever) reached. The airflow resistance R in turn can be calculated by means of the formula

$$R = \frac{tan ( φ )}{2 π fC}$$

wherein f is a frequency of the sinusoidal airflow q_{gen}, wherein o is a phase shift between the sinusoidal airflow q_{gen} and the pressure difference Δp, wherein C=V_{shf}/(p₀−pₑₓₜ) is a pressurized air capacity of the closed volume, wherein V_{shf} is the size of the volume shifted by the pressure generator and wherein p₀ is an actual or mean value of the internal pressure pᵢₙₜ. Advantageously, the frequency f can be in a range lower than 25 Hz in the given context.

In an advantageous embodiment, a movement of the piston 11 and thus of the surface D1 for a second measurement, i.e. for a second detection of the change of the measured pressure difference Δp over time t in case a) or of the airflow q_{gen} into or out of the closed volume B in case b) starts from a position, which was reached for a preceding first measurement or detection respectively. In other words, a back movement of the piston 11 between measurements can be saved. Instead, a subsequent change of the internal pressure pᵢₙₜ starts from where a preceding change of the internal pressure pᵢₙₜ ended. If there is no possibility for moving the piston 11 further in a first excitation direction, the excitation direction can be reversed, and the piston 11 can be moved in a second opposite excitation direction for one or more changes of the internal pressure pᵢₙₜ. However, one should consider that the size of the closed volume B changes during subsequent detections in this embodiment.

In another beneficial embodiment, the internal pressure pᵢₙₜ can be changed to the external pressure pₑₓₜ by the pressure generator 5a before the test object 3a is removed from the test device 2a. That means that the movement of the piston 11 is reversed after the measurement. In this way, air turbulences when the internal pressure pᵢₙₜ and the external pressure pₑₓₜ are equalized during taking off the test object 3a from the test device 2a can be avoided or at least substantially be suppressed.

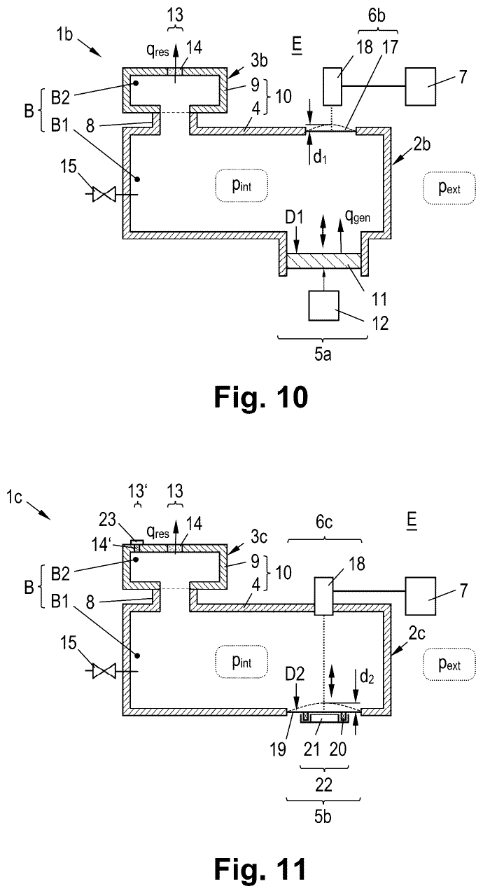

FIG. 10 now shows an alternative embodiment of a test arrangement 1b, which is very similar to the test arrangement 1a of FIG. 1. In contrast, the test arrangement 1b comprises a passive membrane 17, which is arranged in the test device housing 4, and a laser distance sensor 18, which is directed to the passive membrane 17 and which measures a deflection d₁ thereof. In this way, the passive membrane 17 and the laser distance sensor 18 form the pressure sensor 6b or are at least part thereof. It is noted that the aforementioned embodiments, in particular those illustrated with the FIGS. 2 to 9, equally apply to the test arrangement 1b.

The passive membrane 17 cannot only used for the pressure sensor 6b, but may also be used for virtually increasing the size of the closed volume B.

“Virtual volume increase” in this context particularly means that the size of the closed volume B for the concerns of the measurement of the airflow resistance R is increased although in fact it substantially stays the same. According to the gas equation, the following relation is true:

$$\frac{{p}_{2}}{{p}_{1}} = \frac{{V}_{1}}{{V}_{2}} = \frac{{V}_{1}}{{V}_{1} - Δ V}$$

wherein V₁ is the size of the closed volume B at the pressure p₁, V₂ is the size of the closed volume B at the pressure p₂, and AV is a volume change. The passive membrane 17, which is soft compared to the rigid enclosure 10, bends when an inflow q_{gen} into or outflow q_{gen} out of the closed volume B is generated by the pressure generator 5a. So, for the same pressure difference, a higher volume change AV as without the passive membrane 17 is needed. This also means that for the same pressure ratio p₂/p₁, V₁ must “virtually” be increased in the above equation if a passive membrane 17 is used.

Beneficially, the passive membrane 17 has a size in a range of 0.4 to 25 cm² and a compliance in the region of 1 to 30 mm/N. In particular, the ranges are interlinked in a way that an increasing range for the size is interlinked with a decreasing range of the compliance. That means that the parameters size and compliance of the passive membrane 17 range from 0.4 cm² combined with 30 mm/N to 25 cm² combined with 1 mm/N. Accordingly, a virtual increase of the size of the closed volume B ranges from 6 cm³ (with a size and a compliance of the passive membrane of 0.4 cm² and 30 mm/N) to 625 cm³ (with a size and a compliance of the passive membrane of 25 cm² and 1 mm/N).

FIG. 11 shows a further embodiment of a test arrangement 1c, which is similar to the test arrangement 1b of FIG. 10. In contrast, the pressure generator 5b is not embodied as piston compressor but as a speaker. The speaker 5b comprises an actively deflectable membrane 19, a speaker voice coil 20 and a speaker magnet system 21, wherein the speaker voice coil 20 and the speaker magnet system 21 form a speaker motor 22 or are at least parts thereof and wherein the upper surface D2 of the membrane 19 adjoins the closed volume B. The function of a speaker 5b is generally known and hence not explained in detail here. A current through the speaker voice coil 20, which is arranged in the magnetic field of the speaker magnet system 21, causes a driving force, which deflects the membrane 19 and thus causes a volume change rate or a (virtual) airflow q_{gen}. It should be noted that the membrane 19 can deflect as a whole or can comprise an inner part, which moves like a piston and an outer part, which is deflected. The membrane 19 is movable in a controlled manner. That means that the speaker motor 22 is connected to or comprises an open or closed loop control to control the deflection or excitation of the membrane 19 (see also FIG. 7 in this context). Advantageously, the membrane 19 can be moved very fast and its movement can be controlled very precisely so that fast and exact pressure changes are possible. In particular, there is no stick-slip effect (sudden transition from static friction to sliding friction) as it is the case, for example, with piston compressors 5a.

Further on, the laser distance sensor 18 is arranged in the test device housing 4 in this example. The laser distance sensor 18 is directed onto the active membrane 19 of the speaker 5b and measures a deflection de thereof. In this way, the volume change rate or airflow q_{gen} can be measured. In case that the test arrangement 1c is airtight or if the airflow resistance R is very high, the laser distance sensor 18 and the active membrane 19 even can be used to measure the internal pressure pᵢₙₜ, wherein the laser distance sensor 18 and the active membrane 19 form the pressure sensor 6c or are at least part thereof.

It is noted that the aforementioned embodiments, in particular those illustrated with the FIGS. 2 to 10, equally apply to the test arrangement 1c. Particularly, the test arrangement 1c depicted in FIG. 11 may have an additional pressure sensor 6a as the case may be.

It is also advantageous in the context of the speaker 5b if its membrane 19, before changing an internal pressure pᵢₙₜ by a deflection in a first excitation direction, is deflected in a second opposite excitation direction starting from its idle position. In other words, the membrane 19 is deflected outwards before the internal pressure pᵢₙₜ and the external pressure pₑₓₜ are equalized before a measurement and if the internal pressure pᵢₙₜ for the measurement is increased. Similarly, the membrane 19 is deflected inwards before the internal pressure pᵢₙₜ and the external pressure pₑₓₜ are equalized before a measurement if the internal pressure pᵢₙₜ for the measurement is decreased. By these measures, the total excitation of the membrane 19 for compressing or decompressing the closed volume B can be increased. This method may also be applied to a piston compressor 5a but is particularly advantageous in the context of a speaker 5b with comparably small total shifted volume V_{shf}.

Advantageously, a deflection de of the membrane 19 for a second measurement, i.e. for a second detection of the change of the measured pressure difference Δp over time t in case a) or of the airflow q_{gen} into or out of the closed volume B in case b) can start from a position, which was reached for a preceding first measurement. In other words, a back deflection of the membrane 19 between measurements can be saved like it was already explained in the context of the piston 11 of the pressure generator 5a.

In another advantageous embodiment, changing the internal pressure pᵢₙₜ by increasing the same for a first measurement (i. e. a first detection of the change of the measured pressure difference Δp over time t in case a) or of the airflow q_{gen} into or out of the closed volume B in case b)) and changing the internal pressure pᵢₙₜ by decreasing the same for a subsequent, second measurement or detection takes place in alternation. In this embodiment, a deflection of the membrane 19 both in a first excitation direction and in a second opposite excitation direction can be used for a measurement. So, a back deflection of the membrane 19 between detections according to case a) or b) can be saved. In other words, the proposed measures allow for a very fast sequence of subsequent detections. In addition, air turbulences when the internal pressure pᵢₙₜ and the external pressure pₑₓₜ are equalized during a back deflection are avoided or at least substantially suppressed. This method may equally be applied to the piston compressor 5a, where movements of the piston 11 in a first excitation direction and in a second opposite excitation for subsequent measurements take place in alternation.

In FIG. 11, the test object 3a comprises an optional additional aperture 13′ and an optional additional mesh 14′. Moreover, an aperture seal 23 is arranged on the additional aperture 13′ to seal the same. Generally, a test arrangement 1c may have one or more apertures 13, 13′ and/or one or more meshes 14, 14′ in the enclosure 10 of the closed volume B. Advantageously, one or more of the apertures 13, 13′ and/or one or more of the meshes 14, 14′ can be sealed before the internal pressure pᵢₙₜ is changed. In this way, on the one hand, the airtightness of the enclosure 10 can be tested if the one or more intended or known apertures 13, 13′ and/or meshes 14, 14′ are sealed before the measurement. On the other hand, the measurement of an airflow resistance R can be limited to one or more specific apertures 13, 13′ and/or meshes 14, 14′ in the enclosure 10 which are kept open. In FIG. 11, the aperture 13 and the mesh 14 are kept open. That is why the airflow resistance R of the aperture 13 and the mesh 14 can be measured in this configuration. However, if the aperture 13 and the mesh 14 are sealed and the additional aperture 13′ and the additional mesh 14′ are kept open, the airflow resistance R of the additional aperture 13′ and the additional mesh 14′ can be measured. If all apertures 13, 13′ and meshes 14, 14′ are sealed, the airtightness of the enclosure 10 and in particular of the test object housing 9 can be measured. It is noted that these measures can be applied to any of the aforementioned embodiments independent of the other features of the test arrangement 1c.

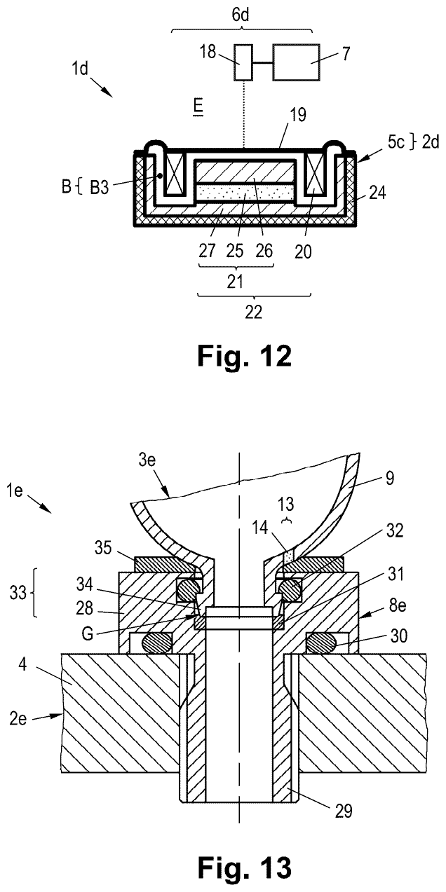

In the aforementioned embodiments, a dedicated test object 3a . . . 3c has been connected to the test device 1a . . . 1c. However, this is no necessary condition, and the test device 2a . . . 2c may also be tested as such, i. e. the airflow resistance R of the test device housing 4 may be measured. This is particularly useful if a speaker 5b is used as a pressure generator. FIG. 12 in this context shows a schematic cross sectional view of an exemplary speaker 5c, which at the same time forms the test device 2d. The speaker 5c comprises a speaker housing 24, in which the magnet system 21 is arranged, wherein the magnet system 21 in this particular embodiment comprises a magnet 25, a top plate 26 made of soft iron and a pot 27 made of soft iron. The closed volume B is formed by the back volume B3 of the speaker 5c. Again, the laser distance sensor 18 measures a deflection de of the membrane 19. Accordingly, the evaluation circuit 7 can be used to measure the volume change rate or (virtual) airflow q_{gen} and/or the internal pressure pᵢₙₜ (the latter under the condition that the speaker 5c is airtight or almost airtight) as explained for the test arrangement 1c of FIG. 11. Note that the speaker housing 24 may comprise an aperture 13 and/or a mesh 14 as the case may be. Accordingly, also the airflow resistance R of such an aperture 13 and/or a mesh 14 can be measured.

As has been mentioned hereinbefore, the measured airflow resistance R can be qualified as infinite if it is larger than 300·10⁹ Pa·s/m³ or 300 Acoustic GOhm respectively. However, in another variant, the measured airflow resistance R can be qualified as infinite
if a drop of a resonance frequency of the speaker 5c caused by the measured airflow resistance R is less than 1% in view of the resonance frequency of the speaker 5c in the airtight condition or
if a change of an impedance frequency response curve of the speaker 5c caused by the measured airflow resistance R at any frequency is less than 1% in view of the impedance of the speaker 5c in the airtight condition.

Generally, if a leakage is too high, apart from a drop of the resonance frequency the excursion of the speaker membrane 19 rises in view of an excursion in the airtight condition provided the same electrical signal is applied to the speaker 5c. This may lead to undesired noise and mechanical problems because the speaker membrane 19 may hit parts of the speaker 5c or parts of a device, which the speaker 5c is built into. Accordingly, it is of advantage if the airflow resistance R is qualified as infinite what also means that the speaker 5c is airtight under the above conditions.

FIG. 13 now shows a cross sectional view of an advantageous connector 8e for connecting a test object 3e to the test device 2e, wherein the connector 8e comprises a connector base body 28 with a threaded shaft 29, by which the connector 8e is mounted to the test device housing 4. In addition, the connector 8e comprises a connector base sealing 30 to seal the connection between the connector 8e and the test device 2e. Moreover, the connector 8e comprises an inner flat sealing 31 and an axially outer O-ring 32 displaced thereof.

The test object 3e comprises a tube section 33 with an outer collar 34 with rounded or chamfered edges G. In the inserted condition the end of the tube section 33 compresses the inner flat sealing 31 and the collar 34 compresses the outer O-ring 32. In this way, the connection between the connector 8e and the test object 3e is sealed. Beneficially, the O-ring 32 holds the test object 3e back in the inserted condition without an external force. In other words, a kind of an airtight snap-in connection is formed. However, the snap-in connection can be released again if the test object 3e is pulled out of the connector 8e with a force exceeding the hold back force generated by the O-ring 32. This kind of connector 8e is particularly useful if the test object 3e is formed by an in-ear headphone.

Here the advantages of the comparably small pressure difference Δp of 1 Pa to 480 Pa are particularly evident, because on the one hand, it allows for a simple insert and remove of the test object 3e without the need of tools and on the other hand, for a fast testing method. Moreover, the comparably small pressure difference Δp does not form a risk for the in-ear headphones as such. That means that there is no risk that parts of the in-ear headphones break because of the pressure. All in all, the proposed connector 8e is particularly useful in a high speed production line of in-ear headphones with short cycle times.

In yet another advantageous embodiment, the connector 8e comprises an additional outer flat sealing 35 which is arranged axially out of the outer O-ring 32 and which is displaced thereof. The additional outer flat sealing 35 in the inserted condition closes an aperture 13 or mesh 14 of the test object 3e. So, airtightness of the test object 3e can be measured, even if the test object housing 9 comprises an aperture 13 or mesh 14, which allow for pressure equalization when the in-ear headphones are inserted into the ear canal of a user and for noticing sound in the environment of the user.

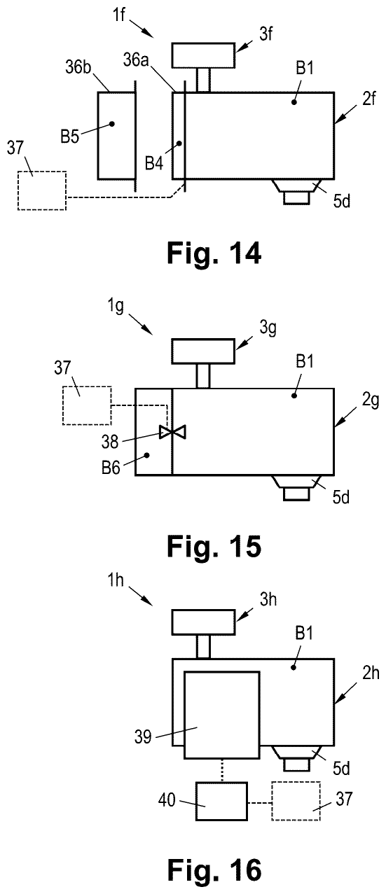

FIGS. 14 to 16 now schematically show various embodiments of test arrangements 1f . . . 1h, which have volume changing means 36a, 36b, 38, 39 for altering or changing the (base) size of the closed volume B what is advantageous if large ranging airflow resistances R shall be measured with the test device 2f . . . 2h. In particular, the size of the closed volume B can be varied to adapt it to the range of the expected or measured airflow resistance R. More particularly, the closed volume B can be enlarged to increase the resolution of the measurement, and the closed volume B can be reduced to reduce the test time.

In detail, FIG. 14 shows a test arrangement 1f, where the volume changing means 36a, 36b are embodied as a set of exchangeable housing parts. One of the exchangeable housing parts 36a, 36b can be connected to the test device housing 4 each and then adjoins a part B4, B5 of the closed volume B in a mounted position. The part B4, B5 of the adjoined closed volume B of the different housing parts 36a, 36b is different. The test device 2f additionally comprises an optional volume changing control 37, which monitors a state of the volume changing means 36a, 36b and the size of the closed volume B during measurement of the airflow resistance R and outputs an alert if said state and said size changes during measurement of the airflow resistance R. For example, the exchangeable housing parts 36a, 36b can have an identification, which is linked to the part B4, B5 of the adjoined closed volume B and which is read by the volume changing control 37. In this way, errors about the used housing part 36a, 36b can be prevented, and a valid measurement of the airflow resistance R can be ensured. The volume changing control 37 alternatively or in addition may be adapted to keep a state of the volume changing means 36a, 36b and the size of the closed volume B the same during measurement of the airflow resistance R. For example, a housing part 36a, 36b may (actively) be locked to the test device 2f during measurement.

FIG. 15 shows an alternative embodiment of a test arrangement 1g with volume changing means 38, which comprise at least one volume changing gate valve or vent, by which an additional volume B6 can be connected to or disconnected from the closed volume B. Again, an optional volume changing control 37 can be provided for the same reasons as above, but which in this embodiment monitors and/or locks the state of the volume changing gate valve or vent 38 (open vs. closed). In FIG. 15 there is just one the volume changing gate valve or vent 38, however, there may be more than one additional volume B6 and volume changing gate valve or vent 38, wherein the additional volumes B6 and volume changing gate valves or vents 38 may be arranged in series or in parallel.

FIG. 16 finally shows yet another alternative embodiment of a test arrangement 1h with volume changing means 39, which are formed by a volume changing piston, which adjoins the closed volume B and which is movable by a volume changing actuator 40 (e.g. by a spindle drive). This volume changing piston 39 shall not be confused with the piston 11 of the pressure generator 5a, because the volume changing piston 39 is not intended for generating the pressure difference Δp but for changing the size of the closed volume B before the internal pressure pᵢₙₜ is changed for a measurement of the airflow resistance R. Usually, the volume changing piston 39 is intended for a much higher volume change and usually is much slower than this is the case for the pressure generator 5a. Again, an optional volume changing control 37 can be provided for the same reasons as above. The volume changing control 37 may be provided for monitoring and/or locking an excitation of the volume changing piston 39.

In the test arrangements 1f . . . 1h of FIGS. 14 and 16 a speaker 5d is used as a pressure generator. However, a skilled person easily understands that a piston compressor 5a or any other pressure generator may equally be used. It is also noted that the test arrangements 1f . . . 1h of FIGS. 14 and 16 may be combined with any of the aforementioned embodiment or features thereof.

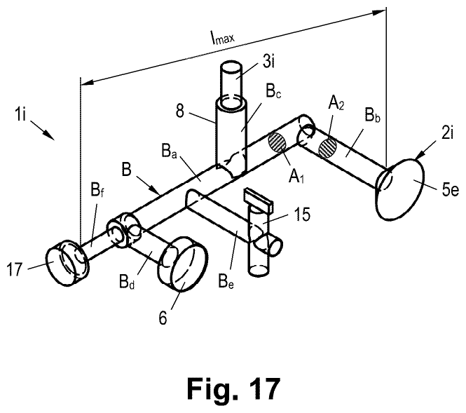

Finally, FIG. 17 shows a schematic angular view of yet another test arrangement 1i with a test device 2i and test object 3i. The test device 2i comprises a pressure generator 5e, a pressure sensor 6, a connector 8, a vent 15 and a passive membrane 17. The functions of the parts of the test arrangement 1i can be the same as explained for the aforementioned embodiments and is not explained in detail here once more. The closed volume B comprises a plurality of elongated sections Bₐ . . . B_{f} in this embodiment. Beneficially, a variation of a cross sectional area A1, A2 of the elongated sections Bₐ . . . B_{f} is in a range of ±30% of an average cross sectional area of the elongated sections Bₐ . . . Br. In that, on the one hand, comparably small, closed volumes V can be realized, on the other hand, necessary distances between necessary connections on the test device housing 9 can be provided. For example, the pressure generator 5e, the pressure sensor 6, the connector 8, the vent 15 and the passive membrane 17 have a particular size so that the cannot be arranged arbitrarily close to each other. Further on, the limited variation of the cross sectional areas A1, A2 of the elongated sections Bₐ . . . B_{f} ensures that narrowings causing substantial unwanted echoes are avoided. The cross section A1, A2 of the elongated sections Bₐ . . . B_{f} may have any desirable shape, for example a circular shape or polygonal shape. If the elongated sections Bₐ . . . B_{f} have a circular shape, the closed volume B at least partially may be formed by (interconnected) bores in the test device housing 4.

It should be noted at this point that the technical disclosure of the FIGS. each or in any combination without the features of the independent claims or at least without the characterizing features of the independent claims may form the basis for an independent claim. So, for example, the technical disclosure of FIG. 5, in particular combined with the technical disclosure of FIG. 11, may form the basis for an independent claim without the characterizing features of the independent claims. However, the example is just illustrative and may not construed as limiting the possibilities for making other independent claims.

Finally it is noted that the scope of the present invention is defined by the appended claims, including known equivalents and unforeseeable equivalents at the time of filing of this application. Although numerous embodiments of this invention have been described above with a certain degree of particularity, those skilled in the art could make numerous alterations to the disclosed embodiments without departing from the spirit or scope of this disclosure.

### LIST OF REFERENCES AND FORMULA SYMBOLS

1a . . . 1i test arrangement
2a . . . 2i test device
3a . . . 3i test object
4 test device housing
5a piston compressor (pressure generator)
5b . . . 5e speaker (pressure generator, acoustic transducer)
6, 6a . . . 6d pressure sensor
7 evaluation circuit
8, 8e connector for test object
9 test object housing
10 enclosure of closed volume
11 piston
12 pressure generator actuator
13, 13′ aperture
14, 14′ mesh (material for acoustic component)
15 vent
16 pressure control
17 passive membrane
18 laser distance sensor
19 actively deflectable membrane (acoustic component)
20 speaker voice coil
21 speaker magnet system
22 speaker motor
23 aperture seal
24 speaker housing
25 magnet
26 top plate
27 pot
28 connector base body
29 threaded shaft
30 connector base sealing
31 inner flat sealing
32 outer O-ring
33 tube section
34 outer collar
35 additional outer flat sealing
36a, 36b exchangeable housing part (volume changing means)
37 volume changing control
38 volume changing gate valve or vent (volume changing means)
39 volume changing piston (volume changing means)
40 volume changing actuator (spindle drive)
A1, A2 cross sectional area of elongated section
B closed volume
B1 test device housing volume
B2 test object housing volume
B3 speaker back volume
B4, B5 volume of exchangeable housing part
B6 additional volume
Bₐ . . . B_{f} elongated sections of closed volume
C pressurized air capacity
D1 movable pressure generator surface
D2 deflectable pressure generator surface
E (external) environment
G rounded/chamfered edge
R airflow resistance
Rₑₛₜ estimated airflow resistance
V size of closed volume
V_{shf} shifted volume
d₁, d₂ deflection of membrane (d₁ passive/d₂ active)
lmax maximum total linear extension of the closed volume
p pressure
pᵢₙₜ internal pressure
pₑₓₜ external pressure
p₀ limiting value of internal pressure
p₀′ internal pressure at start of second pressure change
p₁, p₂ pressure at measuring point
Δp pressure difference
Δpₜₐᵣ target value for pressure difference
p_{A}, p_{A1}, p_{A2} approximated internal pressure
dpᵢₙₜ/dt time gradient of first exponential pressure change
dpᵢₙₜ′/dt time gradient of second exponential pressure change
q_{gen} volume change rate or air flow generated by pressure generator
q₁ . . . q₄ constant air flow
qₜₐᵣ target value air flow
qᵣₑₛ air flow through aperture or mesh
s_{driv} driving signal for pressure generator
t time
t_{ch1} duration of first pressure change
t_{ch2} duration of second pressure change
t_{ch1}′ duration of first alternative first pressure change
t_{ch1}″ duration of second alternative first pressure change
t_{end} change end time
t_{hld} hold time
tₘₛᵣ (total) measuring time
t₀ start time of first pressure change
t₀′ start time of second pressure change
t₁, t₂ measuring time point
t₁′, t₂′ time point of airflow change
T time period of periodically changing internal pressure
f frequency of a sinusoidal airflow
φ phase shift between sinusoidal airflow and pressure difference
τ_{ch1} time constant of first exponential pressure change
τ_{ch2} time constant of second exponential pressure change
τ_{ch1}′ time constant of exponential function
τ_{A1}, τ_{A2} time constant of approximated exponential pressure change

What is claimed is:

1. A method for measuring an airflow resistance of an enclosure (10) of a closed volume (B), comprising the steps of
changing an internal pressure (pᵢₙₜ) within the closed volume (B) in view of an external pressure (pₑₓₜ) in the environment (E) of the closed volume (B) by a pressure generator (5a . . . 5e),
measuring a pressure difference (Δp) between the internal pressure (pᵢₙₜ) and the external pressure (pₑₓₜ) by a pressure sensor (6, 6a . . . 6d) and
a) detecting a change of said measured pressure difference (Δp) over time (t) and deriving the airflow resistance thereof by an evaluation circuit (7) and/or b) detecting an airflow (q_{gen}) into or out of the closed volume (B) generated by the pressure generator (5a . . . 5e) or a volume change rate of the closed volume (B) generated by the pressure generator (5a . . . 5e) and deriving the airflow resistance thereof by the evaluation circuit (7),
wherein
a size of the closed volume (B) is in a range of 2 cm³ to 40 cm³ and the pressure difference (Δp) is in a range of 1 Pa to 480 Pa.

2. The method as claimed in claim 1, wherein the airflow resistance is in a range of 20·10⁶ Pa·s/m³ to 300·10⁹ Pa·s/m³.

3. The method as claimed in claim 1, wherein the airflow resistance R
i) is calculated by means of the formula
$$R = \frac{{τ}_{ch 1}}{C}$$
wherein τ_{ch1} is a time constant of a first exponential change of the internal pressure pᵢₙₜ=p₀−(p₀−pₑₓₜ)·e^{-t}_{ch1}/τ_{ch1} in the closed volume (B) starting at a pressure difference Δp=0, wherein (t_{ch1}) is a duration of the first exponential change, wherein (p₀) is the limiting value of the internal pressure (pᵢₙₜ) in the closed volume (B) after infinite duration (t_{ch1}), wherein C=V_{shf}/(p₀−pₑₓₜ) is a pressurized air capacity of the closed volume (B) and wherein V_{shf} is the size of the volume shifted by the pressure generator (5a . . . 5e) at the duration (t_{ch1}) or
ii) is calculated by means of the formula
$$R = \frac{{τ}_{ch 2}}{C}$$
wherein τ_{ch2} is a time constant of a second exponential change of the internal pressure pᵢₙₜ=p₀′·e^{-tch2/τ}_{ch2} in the closed volume (B) starting at Δp≠0, wherein (p₀′) is the internal pressure in the closed volume (B) at the start of the pressure change, wherein (t_{ch2}) is a duration of the second exponential change, wherein C=V_{shf}/(p₀′−pₑₓₜ) is a pressurized air capacity of the closed volume (B) and wherein V_{shf} is the size of the volume shifted by the pressure generator (5a . . . 5e) at the duration (t_{ch2}).

4. The method as claimed in claim 1, wherein the airflow resistance R
in case i) is calculated by means of a first approximated internal pressure
p_{A1}=p₀−(p₀−pₑₓₜ)·e^{-t}_{ch1/τA1}, which is approximated to the real internal pressure
pᵢₙₜ=p₀−(p₀−pₑₓₜ)·e^{-t}_{ch1/τch1}, wherein τ_{A1} is a time constant of an exponential change of the first approximated internal pressure p_{A1}, or
in case ii) is calculated by means of a second approximated internal pressure p_{A2}=p₀′·e^{-tch2/τA2}, which is approximated to a real internal pressure
pᵢₙₜ=p₀′·e^{-tch2/τch2}, wherein τ_{A2} is a time constant of an exponential change of the second approximated internal pressure p_{A2}.

5. The method as claimed in claim 1, wherein the airflow resistance R
i) is calculated by means of the formula
$$R = \frac{1}{{q}_{gen}} \cdot \frac{{dp}_{int}}{dt}$$
wherein dpᵢₙₜ/dt is the time gradient of a first exponential change of the internal pressure pᵢₙₜ=p₀−(p₀−pₑₓₜ)·e^{-t}_{ch1}/τ_{ch1} in the closed volume (B) at t_{ch1}=0, wherein the first exponential change starts at a pressure difference Δp=0, wherein τ_{ch1} is a time constant of the first exponential change, wherein (t_{ch1}) is a duration of the first exponential change and wherein (p₀) is the limiting value of the internal pressure (pᵢₙₜ) in the closed volume (B) after infinite duration (t_{ch1}), or
ii) is calculated by means of the formula
$$R = \frac{1}{{q}_{gen}} \cdot \frac{{dp}_{int}^{′}}{dt}$$
wherein dpᵢₙₜ′/dt is the time gradient of a second exponential change of the internal pressure pᵢₙₜ=p₀′·e^{-tch2/τ}_{ch2} in the closed volume (B) at t_{ch2}=0, wherein the second exponential change starts at Δp+0, wherein (p₀′) is the internal pressure in the closed volume (B) at the start of the pressure change, wherein t_{ch2} is a time constant of the second exponential change and wherein (t_{ch2}) is a duration of the second exponential change.

6. The method as claimed in claim 1, wherein the airflow resistance R is calculated by means of the formula
$$R = \frac{Δ p}{{q}_{gen}}$$
wherein the airflow (q_{gen}) is controlled by means of an airflow control and wherein a variation of the airflow (q_{gen}) is kept in a range of ±1% by means of the airflow control and a variation of the pressure difference (Δp) faded down to less than ±1% for use in the above formula or
wherein the pressure difference (Δp) is controlled by means of a pressure control (16) and wherein a variation of the pressure difference (Δp) is kept in a range of ±1% by means of a pressure control (16) and/or wherein a variation of the airflow (q_{gen}) faded down to less than ±1% for use in the above formula.

7. The method as claimed in claim 1, wherein the airflow resistance R is calculated by means of the formula
$$R = \frac{tan ( φ )}{2 π fC}$$
wherein f is a frequency of a sinusoidal airflow (q_{gen}) and (φ) is a phase shift between the sinusoidal airflow (q_{gen}) and the pressure difference (Δp).

8. The method as claimed in claim 1, wherein the internal pressure (pᵢₙₜ) is changed from the external pressure (pₑₓₜ) to the internal pressure (p₀) during a duration (t_{ch1}) of a first alternative first change from 0 to an change end time (t_{end}), which is in a range from 100 ms to 2 s, according to
a ramp function pᵢₙₜ=pₑₓₜ+(p₀−pₑₓₜ)·t_{ch1}′/t_{end},
an exponential function pᵢₙₜ=p₀−(p₀−pₑₓₜ)·e^{-t}_{ch1}′/τ_{ch1}, wherein τ_{ch1}′ is a time constant of the exponential function, wherein (p₀) is the limiting value of the internal pressure (pᵢₙₜ) after infinite duration (t_{ch1}′) and wherein p₀<p₀,
a sine function pᵢₙₜ=pₑₓₜ+(p₀−pₑₓₜ)·sin (t_{ch1}′/t_{end}·90° or
a cosine function pᵢₙₜ=pₑₓₜ+(p₀−pₑₓₜ)·0.5·(1−cos (t_{ch1}′/t_{end}·180°.

9. The method as claimed in claim 1, wherein the internal pressure (pᵢₙₜ) is changed from the external pressure (pₑₓₜ) to the internal pressure (p₀′) in a range of a duration (t_{ch1}″) of a second alternative first change from 10 ms to 100 ms according to a step function.

10. The method as claimed in claim 1, wherein the internal pressure (pᵢₙₜ) is changed over time with a frequency lower than 25 Hz.

11. The method as claimed in claim 1, wherein the pressure generator (5a . . . 5e) generates
a single constant air flow (q_{gen}) or
different sequential constant air flows q₁ . . . q₄.

12. The method as claimed in claim 1, wherein
wherein the internal pressure (pᵢₙₜ) is changed by a method according to claim 11,
wherein an estimated value of the airflow resistance Rₑₛₜ is calculated by a method according to case i) of any one of claims 3 to 5,
wherein the constant air flow (q_{gen}) is changed to Δp/Rₑₛₜ at a given value of the pressure difference (Δp) and
wherein the airflow resistance R is calculated by a method according to claim 6.

13. The method as claimed in claim 1, wherein the measured airflow resistance is qualified as infinite if it is larger than 300·10⁹ Pa·s/m³ or 300 Acoustic GOhm respectively.

14. The method as claimed in claim 1, applied to a speaker (5b . . . 5e) having a back volume (B3) at least partially encompassed by a speaker housing (24), wherein
the back volume (B3) forms the closed volume (B) and
the pressure generator (5b . . . 5e) is formed by a speaker motor (22) coupled to an actively deflectable membrane (19) of the speaker (5b . . . 5e).

15. The method as claimed in claim 1,
wherein a speaker (5b . . . 5e) is provided as the pressure generator (5a . . . 5e), an actively deflectable membrane (19) of which adjoins the closed volume (B) and
wherein said membrane (19), before changing an internal pressure (pᵢₙₜ) by a deflection of the membrane (19) in a first excitation direction, is deflected in a second opposite excitation direction starting from its idle position.

16. The method as claimed in claim 14, wherein the pressure sensor (6, 6a . . . 6d) is formed by the actively deflectable membrane (19) of the speaker (5b . . . 5e) and a laser distance sensor (18) directed to the actively deflectable membrane (19), wherein the laser distance sensor (18) measures a deflection of said membrane (19).

17. The method as claimed in claim 1, wherein a movement or a deflection of a surface (D1, D2) of the pressure generator (5a . . . 5e), which surface (D1, D2) adjoins the closed volume (B), for a second detection of the change of the measured pressure difference (Δp) over time (t) in case a) or of the airflow (q_{gen}) into or out of the closed volume (B) in case b) starts from a position, which was reached for a preceding first detection.

18. The method as claimed in claim 1, wherein
changing the internal pressure (pᵢₙₜ) by increasing the same in view of an external pressure (pₑₓₜ) for a first detection of the change of the measured pressure difference (Δp) over time (t) in case a) or of the airflow (q_{gen}) into or out of the closed volume (B) in case b) and
changing the internal pressure (pᵢₙₜ) by decreasing the same in view of an external pressure (pₑₓₜ) for a subsequent, second detection takes place in alternation.

19. The method as claimed in claim 1, wherein the internal pressure (pᵢₙₜ) is changed to the external pressure (pₑₓₜ) by the pressure generator (5a . . . 5e) before a test object (3a . . . 3e) forming or comprising the enclosure (10) is removed from the test device (2a . . . 2i).

20. The method as claimed in claim 1, wherein the measured airflow resistance is qualified as infinite
if a drop of a resonance frequency of the speaker (5b . . . 5e) caused by the measured airflow resistance is less than 1% in view of the resonance frequency of the speaker (5b . . . 5e) in the airtight condition or
if a change of an impedance frequency response curve of the speaker (5b . . . 5e) caused by the measured airflow resistance at any frequency is less than 1% in view of the impedance of the speaker (5b . . . 5e) in the airtight condition.

21. The method as claimed in claim 1, wherein one or more apertures (13, 13′) and/or one or more meshes (14, 14′) in the enclosure (10) of the closed volume (B) are sealed before the internal pressure (pᵢₙₜ) is changed.

22. A test device (2a . . . 2i) for measuring an airflow resistance of an enclosure (10) of a closed volume (B), comprising
a test device housing (4), which at least partly encloses the closed volume (B),
a pressure generator (5a . . . 5e), which is connected to the test device housing (4) and which is provided to change an internal pressure (pᵢₙₜ) within the closed volume (B) in view of an external pressure (pₑₓₜ) in the environment (E) of the closed volume (B),
a pressure sensor (6, 6a . . . 6d), which is designed to measure a pressure difference (Δp) between the internal pressure (pᵢₙₜ) and the external pressure (pₑₓₜ), and
an evaluation circuit (7), which is designed a) to detect a change of said measured pressure difference (Δp) over time (t) and to derive the airflow resistance thereof and/or b) to detect an airflow (q_{gen}) into or out of the closed volume (B) generated by the pressure generator (5a . . . 5e) or a volume change rate of the closed volume (B) generated by the pressure generator (5a . . . 5e) and to derive the airflow resistance thereof,
wherein
a size of the closed volume (B) is in a range of 2 cm³ to 40 cm³ and the pressure difference (Δp) is in a range of 1 Pa to 480 Pa.

23. The test device (2a . . . 2i) as claimed in claim 22, wherein the pressure generator (5a . . . 5e) comprises a surface (D1, D2) being movable or deflectable in a controlled manner, wherein the surface (D1, D2) adjoins the closed volume (B).

24. The test device (2a . . . 2i) as claimed in claim 22, wherein the pressure generator (5a . . . 5e) is designed as a piston compressor (5a) and wherein the movable surface (D1) is formed by a surface of a piston (11) of the piston compressor (5a).

25. The test device (2a . . . 2i) as claimed in claim 22, wherein the pressure generator (5a . . . 5e) is designed as a speaker (5b . . . 5e) and wherein the deflectable surface (D2) is formed by a surface of an actively deflectable membrane (19) of the speaker (5b . . . 5e).

26. The test device (2a . . . 2i) as claimed in claim 25, wherein the pressure sensor (6, 6a . . . 6d) comprises a laser distance sensor (18), which is directed to the actively deflectable membrane (19) and which is designed to measure a deflection (d₂) thereof.

27. The test device (2a . . . 2i) as claimed in claim 22, additionally comprising a passive membrane (17) arranged in the test device housing (4) and adjoining the closed volume (B).

28. The test device (2a . . . 2i) as claimed in claim 27, wherein the pressure sensor (6, 6a . . . 6d) comprises a laser distance sensor (18), which is directed to the passive membrane (17) and which is designed to measure a deflection (d₁) thereof.

29. The test device (2a . . . 2i) as claimed in claim 22, wherein the passive membrane (17) has a size in a range of 0.4 to 25 cm² and a compliance in the region of 1 to 30 mm/N.

30. The test device (2a . . . 2i) as claimed in claim 22, additionally comprising a vent (15) in the test device housing (4).

31. The test device (2a . . . 2i) as claimed in claim 22, wherein a maximum total linear extension (lₘₐₓ) of the closed volume (B) is smaller than 12 cm.

32. The test device (2a . . . 2i) as claimed in claim 22, wherein the closed volume (B) comprises a plurality of elongated sections (Bₐ . . . B_{f}) and wherein a variation of a cross sectional area (A₁, A₂) of the elongated sections (Bₐ . . . B_{f}) is in a range of ±30% of an average cross sectional area of the elongated sections (Bₐ . . . B_{f}).

33. The test device (2a . . . 2i) as claimed in claim 22, additionally comprising volume changing means (36a, 36b, 38, 39) for changing a size of the closed volume (B), wherein the volume changing means (36a, 36b, 38, 39) are embodied as
a set of exchangeable housing parts (36a, 36b), wherein one of the exchangeable housing parts (36a, 36b) can be connected to the test device housing (4) each and then adjoins a part (B4, B5) of the closed volume (B) in a mounted position and wherein the part (B4, B5) of the adjoined closed volume (B) of the different housing parts (36a, 36b) is different,
at least one volume changing gate valve or vent (38), by which an additional volume (B6) can be connected to or disconnected from the closed volume (B), or
a volume changing piston (39), which adjoins the closed volume (B) and which is movable by a volume changing actuator (40).

34. The test device (2a . . . 2i) as claimed in claim 33, additionally comprising a volume changing control (37),
which is adapted to keep a state of the volume changing means (36a, 36b, 38, 39) and the size of the closed volume (B) the same during measurement of the airflow resistance or
which is adapted to monitor a state of the volume changing means (36a, 36b, 38, 39) and the size of the closed volume (B) during measurement of the airflow resistance and to output an alert if said state and said size changes during measurement of the airflow resistance.

35. The test device (2a . . . 2i) as claimed in claim 22, additionally comprising a connector (8, 8e) for connecting a test object (3a . . . 3e), wherein the connector (8, 8e) is arranged in the test device housing (4).

36. The test device (2a . . . 2i) as claimed in claim 35, wherein the connector (8, 8e) comprises an inner flat sealing (31) and an axially outer O-ring (32) displaced thereof.

37. The test arrangement (1a . . . 1i) comprising a test device (2a . . . 2i) according to claim 35 and a test object (3a . . . 3i) connected thereto by use of the connector (8, 8e), wherein the closed volume (B) is encompassed by the test device housing (4) and a test object housing (9) of the test object (3a . . . 3i).

38. The test arrangement (1a . . . 1i) as claimed in claim 37, wherein the test object (3a . . . 3i) is formed by an acoustic transducer, an acoustic component for an acoustic transducer or a material for an acoustic component of an acoustic transducer.

39. The test arrangement (1a . . . 1i) as claimed in claim 37, wherein the test object (3a . . . 3i) is a mesh or mesh material having an acoustic resistance in a range of 20·10⁶ Pa·s/m³ to 300·10⁹ Pa·s/m³.

40. The test arrangement (1a . . . 1i) as claimed in claim 37 with a test device (2a . . . 2i) as claimed in claim 36, wherein
the test object (3a . . . 3i) comprises a tube section (33) with an outer collar (34) with rounded or chamfered edges (G),
the end of the tube section (33) compresses the inner flat sealing (31) and the collar (34) compresses the outer O-ring (32) in the inserted condition and
the O-ring (32) holds the test object (3a . . . 3i) back in the inserted condition without an external force.

41. The test arrangement (1a . . . 1i) as claimed in claim 40, wherein the connector (8, 8e) comprises an additional outer flat sealing (35) which is arranged axially out of the outer O-ring (32) and which is displaced thereof and the additional outer flat sealing (35) closes an aperture (13, 13′) or mesh (14, 14′) of the test object (3a . . . 3i) in the inserted condition.

42. The method as claimed in claim 15, wherein the pressure sensor (6, 6a . . . 6d) is formed by the actively deflectable membrane (19) of the speaker (5b . . . 5e) and a laser distance sensor (18) directed to the actively deflectable membrane (19), wherein the laser distance sensor (18) measures a deflection of said membrane (19).
